(19) United States
(12) Patent Application Publication
(10) Pub. No.: US 2017/0073581 A1
(43) Pub. Date: Mar. 16, 2017

(54) MIXTURE THAT INCLUDES COMPOUND CONTAINING MESOGENIC GROUP

(71) Applicant: DIC Corporation, Tokyo (JP)

(72) Inventors: Masahiro Horiguchi, Kita-adachi-gun (JP); Mika Yamamoto, Kita-adachi-gun (JP); Yasuhiro Kuwana, Kita-adachi-gun (JP)

(21) Appl. No.: 15/123,364

(22) PCT Filed: Feb. 24, 2015
(86) PCT No.: PCT/JP2015/055177

§ 371 Date: Sep. 2, 2016

(30) Foreign Application Priority Data
Mar. 4, 2014 (JP) 2014-041835

(51) Int. Cl. C09K 19/38; G02B 5/30; B42D 25/364; C08F 222/20

(52) U.S. Cl. CPC C09K 19/3809; C08F 222/20; G02B 5/3016; B42D 25/364; C09K 2019/0448

(57) ABSTRACT

The present invention provides a mixture including a compound that has a mesogenic group and satisfying an expression represented by Expression (1):

1.0≦YI/Δn≦50.0 Expression (1)

wherein YI represents a yellowness index of the mixture and Δn represents a refractive index anisotropy of the compound having a mesogenic group. In a case of producing an optical anisotropic body constituted by a composition prepared by using the compound, repellence hardly occurs, and the mixture exhibits excellent alignment properties in a case of using the optical anisotropic body. Furthermore, a composition that contains the mixture and an optical anisotropic body that uses the composition are provided.

### TECHNICAL FIELD

The present invention relates to a mixture having a value of YI/Δn falling within a specific range, a composition containing the mixture, a polymer obtained by polymerizing a polymerizable composition, an optical anisotropic body obtained by polymerizing the polymerizable composition, and a retardation film obtained by polymerizing the polymerizable composition. Further, the present invention relates to a display device, an optical element, a light-emitting device, a printed material, an optical information recording apparatus, and the like, which have an optical anisotropic body.

### BACKGROUND ART

A polymerizable liquid crystal composition containing a compound having a polymerizable functional group (polymerizable compound) is useful as a constituent member of an optical anisotropic body. The optical anisotropic body has been, for example, applied to a variety of liquid crystal displays as a polarizing film or a retardation film. A polarizing film and a retardation film can be obtained by applying a polymerizable liquid crystal composition on the substrate, and heating the polymerizable liquid crystal composition or irradiating the polymerizable liquid crystal composition with an active energy beam in a state where the polymerizable liquid crystal composition is aligned with an alignment film or the like to thereby cure the polymerizable liquid crystal composition, but there is a problem that the “repellence” occurs in the polymerizable liquid crystal composition on the substrate at the time of applying the polymerizable liquid crystal composition onto the substrate and heating the composition (PTL 1). If the repellence occurs, there is a problem that the evenness of the coating film is impaired, and this would affect the quality of the optical anisotropic body obtained by polymerizing the coating film, and thus the yield is deteriorated.

As a polymerizable liquid crystal composition used for an optical anisotropic body, in many cases, a polymerizable composition containing two or more polymerizable compounds is used in order to satisfy the optical properties, polymerization rate, solubility, melting point, glass transition temperature, transparency of the polymer, mechanical strength, surface hardness, heat resistance, and light resistance which are required. The polymerizable compound used in this case is a compound that is required to impart good physical properties to the polymerizable composition without adversely affecting the other properties. Various polymerizable compounds are known in the related field, but there is a problem that the deterioration such as the formation of a polymer component is caused during long-term storage of the polymerizable compounds. If an optical anisotropic body is prepared by using the polymerizable compound after long-term storage, repellence easily occurs on applying the composition, thereby deteriorating the optical properties such as alignment properties. Therefore, required are materials for a liquid crystal composition that exhibits excellent alignment properties in a case of preparing an optical anisotropic body and can suppress repellence of the polymerizable liquid crystal composition even after long-term storage.

### CITATION LIST

### Patent Literature

[PTL 1] JP-A-2006-39164

### SUMMARY OF INVENTION

### Technical Problem

An object of the present invention is to provide a mixture which hardly causes repellence in a case of preparing an optical anisotropic body with a composition constituted by using the mixture and which exhibits excellent alignment properties in a case of preparing an optical anisotropic body, and also to provide a composition containing the mixture and an optical anisotropic body using the composition.

### Solution to Problem

The present invention provides a mixture including a compound that has a mesogenic group and satisfying an expression represented by Expression (1):

1.0≦YI/Δn≦50.0 Expression (1)

wherein YI represents a yellowness index of the mixture and Δn represents a refractive index anisotropy of the compound having a mesogenic group;

and also, provides a composition containing the mixture, a polymer, an optical anistropic body, and a retardation film.

### Advantageous Effects of Invention

In a case of preparing an optical anisotropic body with a composition constituted by using the mixture of the present invention compound, repellence hardly occurs. Further, an optical anisotropic body using a composition containing the mixture of the present invention exhibits excellent alignment properties and is useful in applications of the optical material such as a retardation film.

### DESCRIPTION OF EMBODIMENTS

Hereinafter, the preferred exemplary embodiments of the present invention will be described.

The “mixture” of the present invention is a material that contains a compound having a mesogenic group and impurities inevitably mixed during the production of the compound having a mesogenic group. The impurities refer to components other than the compound having a mesogenic group in the mixture. In general, the compound having a mesogenic group has been produced through the purification step, but since it is difficult to have completely zero impurities even after the purification step, in practice, the compound considerably contains impurities depending on the degree of purification, and the like. In the present invention, a compound containing such impurities is referred to as a “mixture” in order to clearly distinguish the compound containing no impurities.

The mixture contains impurities, but the content of the compound in the mixture is 80.0% by mass or more, 90.0% by mass or more, 95.0% by mass or more, and 98.0% by mass or more.

In addition, the “composition” of the present invention contains one or more mixtures, and, if necessary, contains compounds that do not contain a mesogenic group, stabilizers, organic solvents, polymerization inhibitors, antioxidants, photopolymerization initiators, thermal polymerization initiators, surfactants, and the like. While the mixture of the present invention is composed of a single compound having a mesogenic group and impurities, the composition of the present invention is distinguished in that the composition contains one mixture and one or more additives or contains two or more mixtures and, if necessary, additives. Further, in the following, the polymerizable composition may be referred to as a polymerizable liquid crystal composition, and the “liquid crystal” means a material that shows crystal properties when applying, printing, or dropping the polymerizable composition onto a substrate, or injecting the polymerizable composition into the cell. The liquid crystal may not necessarily show liquid crystal properties as a composition.

The impurities are removed by a purification step, but the mixture has a problem that the yield is deteriorated by being subjected to the purification step. As the cause, it is considered that the compound is removed along with the impurities in the mixture by being subjected to the purification step, or the compound is adsorbed to a purification agent. Further, in the purification step, in a case where too many compounds may be incorporated into the impurities, or the mixture contains a compound having a polymerizable group, it is also conceivable as a cause that polymer components of impurities that are contained in the mixture in trace amounts are aggregated to each other, and the filtration becomes complicated.

If the yellowness index (YI) of the mixture of the present invention is measured, there is a tendency that as the mixture is more purified, the value of the yellowness index is reduced. The present inventors have focused on the mixture containing the compound having a mesogenic group, and have found that, as a result of intensive studies, the value of yellowness index (YI) of the mixture and the refractive index anisotropy (Δn) of the compound is relevant to the yield. In addition, the present inventors have further examined the value of yellowness index (YI) of the mixture and the refractive index anisotropy (Δn) of the compound, and the inventors have found that the value affects the occurrence of repellence in a case of applying a composition containing the mixture to a substrate, and affects the alignment properties in a case of using the optical anisotropic body which uses the composition.

That is, the mixture according to the present invention is a mixture satisfying the expression represented by Expression (1):

1.0≦YI/Δn≦50.0 Expression (1)

wherein YI represents the yellowness index of the mixture and Δn represents the refractive index anisotropy of the compound having a mesogenic group.

In the case where the above Expression (1) is satisfied, the degree of purification is in an appropriate range, so the high yield may be obtained. Further, in the case where the above Expression (1) is satisfied, favorable compounds for repellence and alignment properties may be obtained in a case of preparing an optical anisotropic body. As a cause of the repellence, although there is a possibility that the amount of the polymer component in the composition, the molecular structure of the compound, and the like affect the repellence, the mixture satisfying the above range is considered to have rigidity of the appropriate polymer component and the compound. In addition, as a cause that affects the alignment properties, although the function of the polymer having the same mesogenic skeleton as the compound generated by polymerizing some compounds is exemplified, the polymer component is uniformly dispersed in the mixture satisfying the above range, and also rigidity is not too high as the structure of the mesogenic skeleton. Further, since the intermolecular interactions occur between the mesogenic moiety in the polymer component and the mesogenic moiety of the compound, it is conceivable that the alignment effect by the polymer component is effectively obtained.

Further, the value of YI/Δn of the mixture is preferably 1.1 or more, preferably 1.5 or more, preferably 5.0 or more, preferably 10.0 or more, preferably 20.0 or more, and preferably 49.0 or less, and preferably 48.0 or less from the viewpoint of obtaining a high yield.

The value of YI/Δn of the mixture is preferably 48.0 or less, and preferably 40.0 or less from the viewpoint of obtaining a favorable value for repellence and alignment properties.

The yellowness index (YI) of the mixture is measured using a tetrahydrofuran solution containing the mixture of the present invention in a proportion of 20% by mass as a measurement object by using a spectrophotometer. In addition, as the solution, a solution other than tetrahydrofuran may be used as long as a sufficient dissolution of the mixture is obtained. For example, cyclopentanone, chloroform, and the like are exemplified. The yellowness index (YI) of the mixture may be calculated by converting the obtained measurement values into the value of the case measured by using a cell where the material solution concentration of the measurement object is 20% and the optical path length is 1 cm.

Also, in a case where the mixture of the present invention is hardly soluble in a hardly soluble solution, the yellowness index (YI) of the mixture is calculated using a solution containing the material in a proportion of 4% by mass as a measurement object and putting the measurement object in a transparent cell having an optical path length of 5 cm by using a spectrophotometer. The yellowness index (YI) of the mixture is calculated by converting the obtained measurement values into the value of the case measured by using a cell where the material solution concentration of the measurement object is 4% and the optical path length is 5 cm.

The refractive index anisotropy of the compound is measured as follows. The compound having a mesogenic group is added to the host liquid crystal to form a liquid crystal composition. A glass cell is generated by using glass substrates in which a polyimide alignment film is attached, in a combination of the two glass substrates such that the substrates are parallel to the rubbing direction of the polyimide alignment film. The film is obtained by being peeled off from the glass cell after injecting the liquid crystal composition to the glass cell and curing the glass cell by radiating ultraviolet rays (illuminance of 800 mJ/cm²). Then, the refractive index anisotropy (Δn) which is extrapolated by the values such that the compound having a mesogenic group is 100% by mass is calculated by measuring the ne and no of the film using Abbe's refractometer.

Then, the value of YI/Δn is obtained by dividing the yellowness index (YI) of the mixture by the refractive index anisotropy of the compound having a mesogenic group.

(Compound Having Mesogenic Group)

As the compound having a mesogenic group, in the related field, as long as the compound exhibits a liquid crystal phase in a case where a plurality of compounds are mixed to form a composition, a compound having one or more polymerizable functional groups in a molecule or a compound having no polymerizable functional group in a molecule may be used without particular limitation. Further, the polymerizable liquid crystal compound alone may not exhibit liquid crystallinity. Here, since the mesogenic group is a group composed of two or more ring structures and a linking group which links these ring structures or a single bond, the group means a portion constituted such that two or more ring structures are linked by a linking group having 2 or fewer atoms having a bond site connecting the ring structure and the ring structure in the shortest path or a single bond.

Among the compounds containing a mesogenic group, in a case of preparing a mixture using the compound having one polymerizable functional group in a molecule, it is easy to make mixtures at low temperature before and after room temperature as a liquid crystal temperature range and thus preferable. Examples of such compounds include a rod-like polymerizable liquid crystal compound having a rigid site as a mesogenic group in which a plurality of structures such as a 1,4-phenylene group, a 1,4-cyclohexylene group, and the like are connected, and having a polymerizable functional group such as a vinyl group, an acryloyl group, a (meth) acryloyl group, which is disclosed in Handbook of Liquid Crystals (edited by D. Demus, J. W. Goodby, G. W. Gray, H. W. Spiess, V. ViII, published by Wiley-VCH Verlag GmbH & Co. KGaA, 1998), Kikan kagaku sosetsu No. 22, Liquid crystal chemistry (edited by the Chemical Society of Japan, 1994), or JP-A-7-294735, JP-A-8-3111, JP-A-8-29618, JP-A-11-80090, JP-11-116538, JP-A-11-148079, and the like, a rod-like polymerizable liquid crystal compound having a maleimide group as disclosed in JP-A-2004-2373 and JP-A-2004-99446, and the like.

Specifically, the liquid crystal compound having two or more of polymerizable functional groups is preferably a compound represented by the following Formula (1).

[Chem. 1]

P¹-(Sp¹)ₘ₁-MG1-R¹ (1)

In the formula, P¹ represents a polymerizable functional group, Sp¹ represents an alkylene group having 0 to 18 carbon atoms (the alkylene group may be substituted by a halogen atom, a CN group or an alkyl group having 1 to 8 carbon atoms and having one or more polymerizable functional groups, one of the CH groups or two or more of the CH₂ groups which are not adjacent to each other present in the alkylene group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), m1 represents 0 or 1, MG1 represents a mesogenic group or a mesogenic supporting group, R¹ represents a hydrogen atom, a halogen atom, a cyano group or an alkyl group having 1 to 18 carbon atoms, and the alkyl group may be substituted by one or more of a halogen atom or a CN group, one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom, or R¹ represents a structure represented by Formula (1-a).

[Chem. 2]

-(Sp^{1a})ₘₐ-P^{1a} (1-a)

In the formula, P^{1a} represents a polymerizable functional group, Sp^{1a} represents the same meaning as Sp¹, and ma represents 0 or 1.

The mesogenic group or the mesogenic supporting group represented by MG1 is represented by Formula (1-b).

[Chem. 3]

—Z0-(A1-Z1)ₚ-(A2-Z2)_{q}-(A3-Z3)ᵣ-A4-Z4-A5-Z5- (1-b)

In the formula, A1, A2, A3, A4, and A5 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and

A1, A2, A3, A4, and A5 may have, as substituents, one or more of F, Cl, CF₃, OCF₃, a CN group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, and a substituent represented by Formula (1-c).

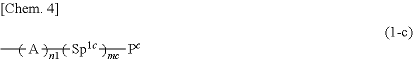

In the formula, P^{c} represents a polymerizable functional group, A represents —O—, —COO—, —OCO—, —OCH₂—, —CH₂O—, —CH₂CH₂OCO—, —COOCH₂CH₂—, —OCOCH₂CH₂—, or a single bond, Sp^{1c} represents the same meaning as Sp¹, but Sp^{1c} and Sp¹ may be the same as or different to each other, n1 represents 0 or 1, and mc represents 0 or 1.

Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond, and

p, q, and r each independently represent 0 or 1, and satisfy 0≦p+q+r≦3.

However, in Formula (1), two or more polymerizable functional groups are present.

P¹, P^{1a}, and P^{c} preferably represent substituents selected from polymerizable groups represented by the following Formulas (P-1) to (P-20).

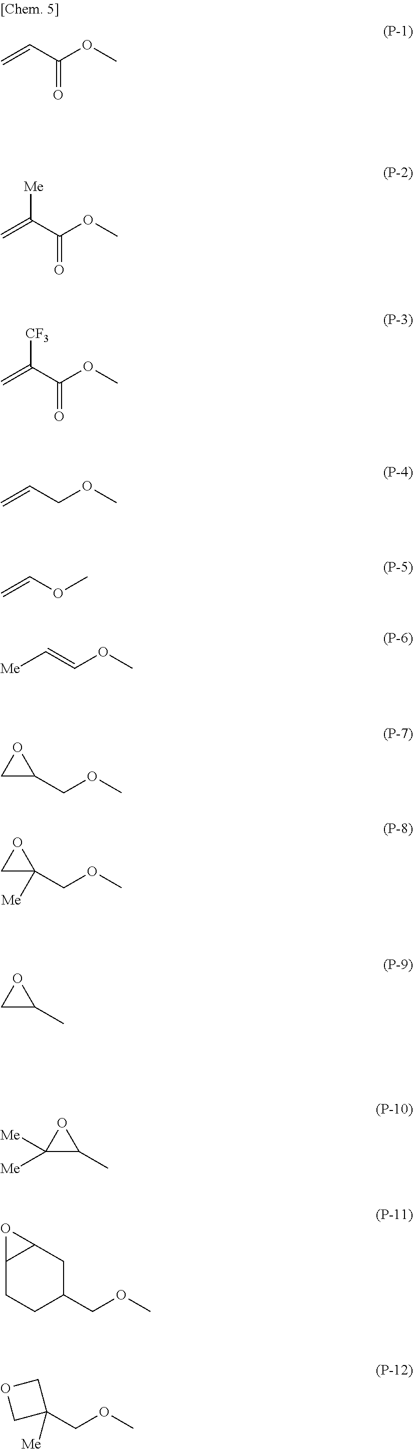

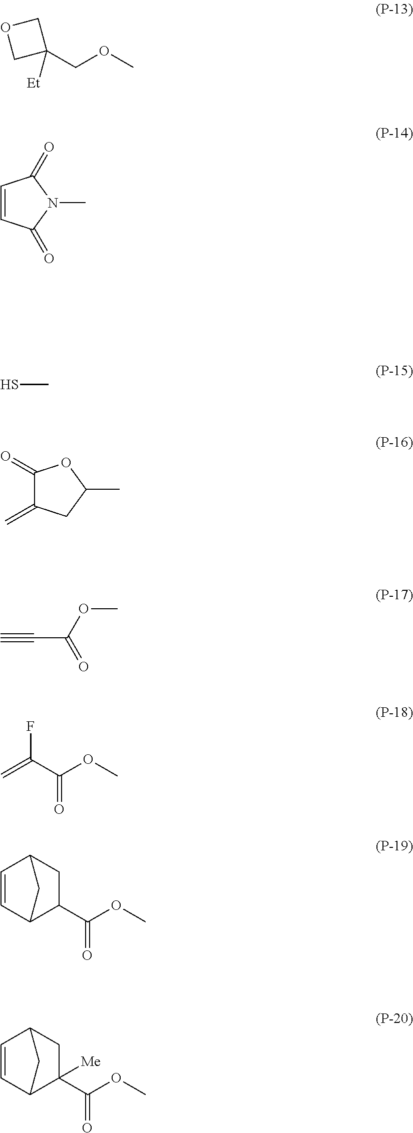

Among these polymerizable functional groups, Formula (P-1), Formula (P-2), (P-7), (P-12), or (P-13) is preferable, and Formula (P-1), (P-2), (P-7), or (P-12) is more preferable, from the viewpoint of enhancing polymerizable properties and storage stability.

One or more liquid crystal compounds having two or more polymerizable functional groups may be used, but one to six liquid crystal compounds are preferably used, and two to five liquid crystal compounds are more preferably used.

The content of the liquid crystal compound having two or more polymerizable functional groups is preferably 5% to 100% by mass, more preferably 10% to 100% by mass, and particularly preferably 15% to 100% by mass in the polymerizable liquid crystal composition. In a case of emphasizing the alignment properties of the optical anisotropic body, the lower limit value is preferably set to be 5% by mass or higher, more preferably 10% by mass or higher, and particularly preferably 15% by mass or higher, and, on the other hand, in a case of emphasizing rigidity, the upper limit value is preferably set to be 90% by mass or lower, more preferably 80% by mass or lower, and particularly preferably 70% by mass or lower.

As the liquid crystal compound having two or more polymerizable functional groups, a compound having two polymerizable functional groups is preferable, and a compound represented by the following Formula (2) is preferable.

[Chem. 6]

P^{2a}-(Sp^{2a})ₘ₂-Z0-(A1^{a}-Z1)ₚ-(A2^{a}-Z2)_{q}-(A3^{a}-Z3)ᵣ-A4^{a}-Z4-A5^{a}-Z5-(Sp^{2b})ₙ₂-P^{2b} (2)

In the formula, A^{1a}, A^{2a}, A^{3a}, A^{4a}, and A^{5a} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and

A1^{a}, A2^{a}, A3^{a}, A4^{a}, and A5^{a} may have, as substituents, one or more F, Cl, CF₃, OCF₃, and CN groups, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms.

In addition, Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, and

p, q, and r each independently represent 0 or 1, and satisfy 0≦p+q+r≦3.

P^{2a} and P^{2b} represent a polymerizable functional group, Sp^{2a} and Sp^{2b} each independently represent an alkylene group having 0 to 18 carbon atoms (the alkylene group may be substituted by one or more of a halogen atom or CN, one of the CH₂ groups or two or more of the CH₂ groups which are not adjacent to each other present in the alkylene group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and m2 and n2 each independently represent 0 or 1.

P^{2a} and P^{2b} preferably represent substituents selected from polymerizable groups represented by the following Formula (P-1) to Formula (P-20).

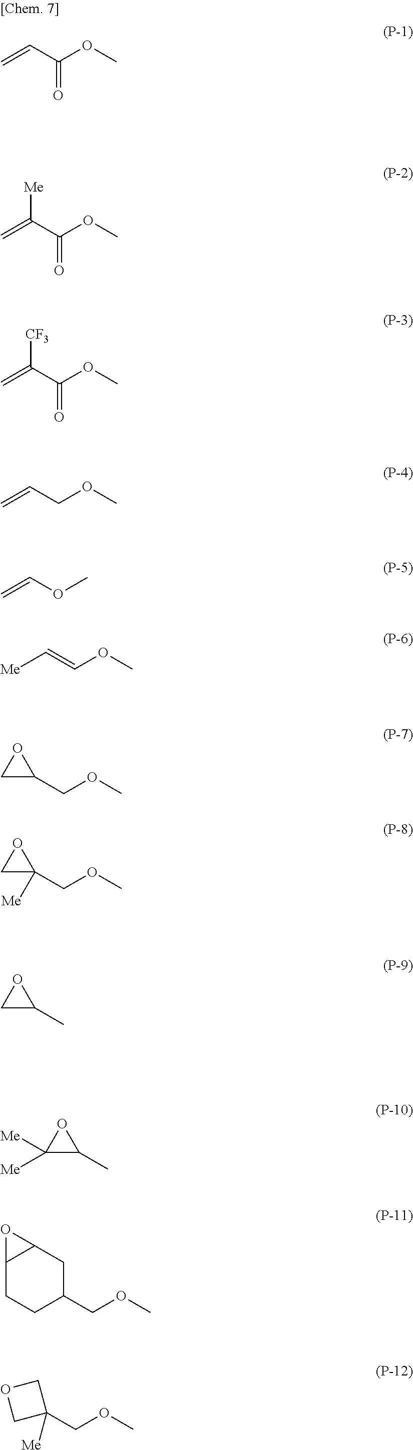

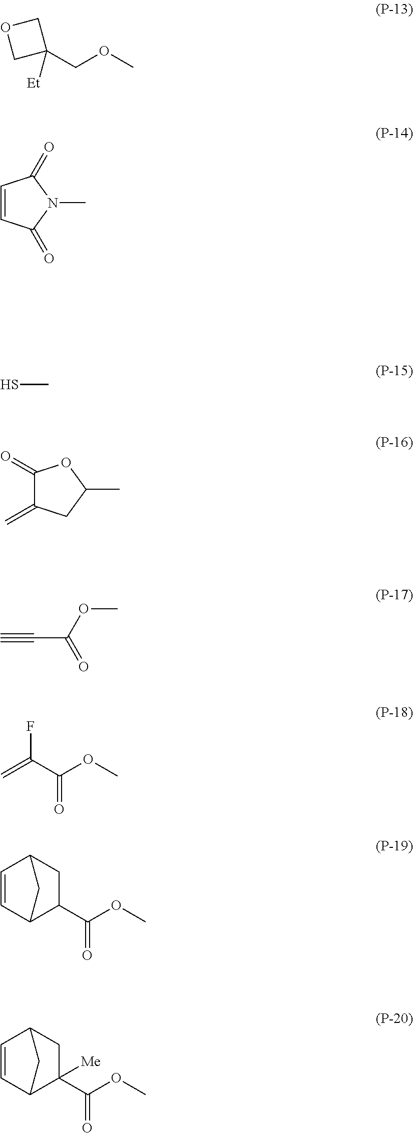

Among these polymerizable functional groups, Formula (P-1), Formula (P-2), (P-7), (P-12), or (P-13) is preferable, and Formula (P-1), Formula (P-2), (P-7), or (P-12) is more preferable, from the viewpoint of enhancing polymerizable properties and storage stability.

Furthermore, as an example of Formula (2), Formulas (2-1) to (2-4) may be exemplified, but Formula (2) is not limited to the following Formulas.

[Chem. 8]

P^{2a}-(Sp^{2a})ₘ₂-Z0-A4^{a}-Z4-A5^{a}-Z5-(Sp^{2b})ₙ₂-P^{2b} (2-1)

P^{2a}-(Sp^{2a})ₘ₂-Z0-A3^{a}-Z3-A4^{a}-Z4-A5^{a}-Z5-(Sp^{2b})ₙ₂-P^{2b} (2-2)

P^{2a}-(Sp^{2a})ₘ₂-Z0-A2^{a}-Z2-A3a-Z3-A4^{a}-Z4-A5^{a}-Z5-(Sp^{2b})ₙ₂-P^{2b} (2-3)

P^{2a}-(Sp^{2a})ₘ₂-Z0-A1^{a}-Z1-A2^{a}-Z2-A3^{a}-Z3-A4^{a}-Z4-A5^{a}-Z5-(Sp^{2b})ₙ₂-P^{2b} (2-4)

Specific examples of the polymerizable liquid crystal compound having two polymerizable functional groups include compounds of Formulas (2-5) to (2-30), but the compound is not limited to the following compounds.

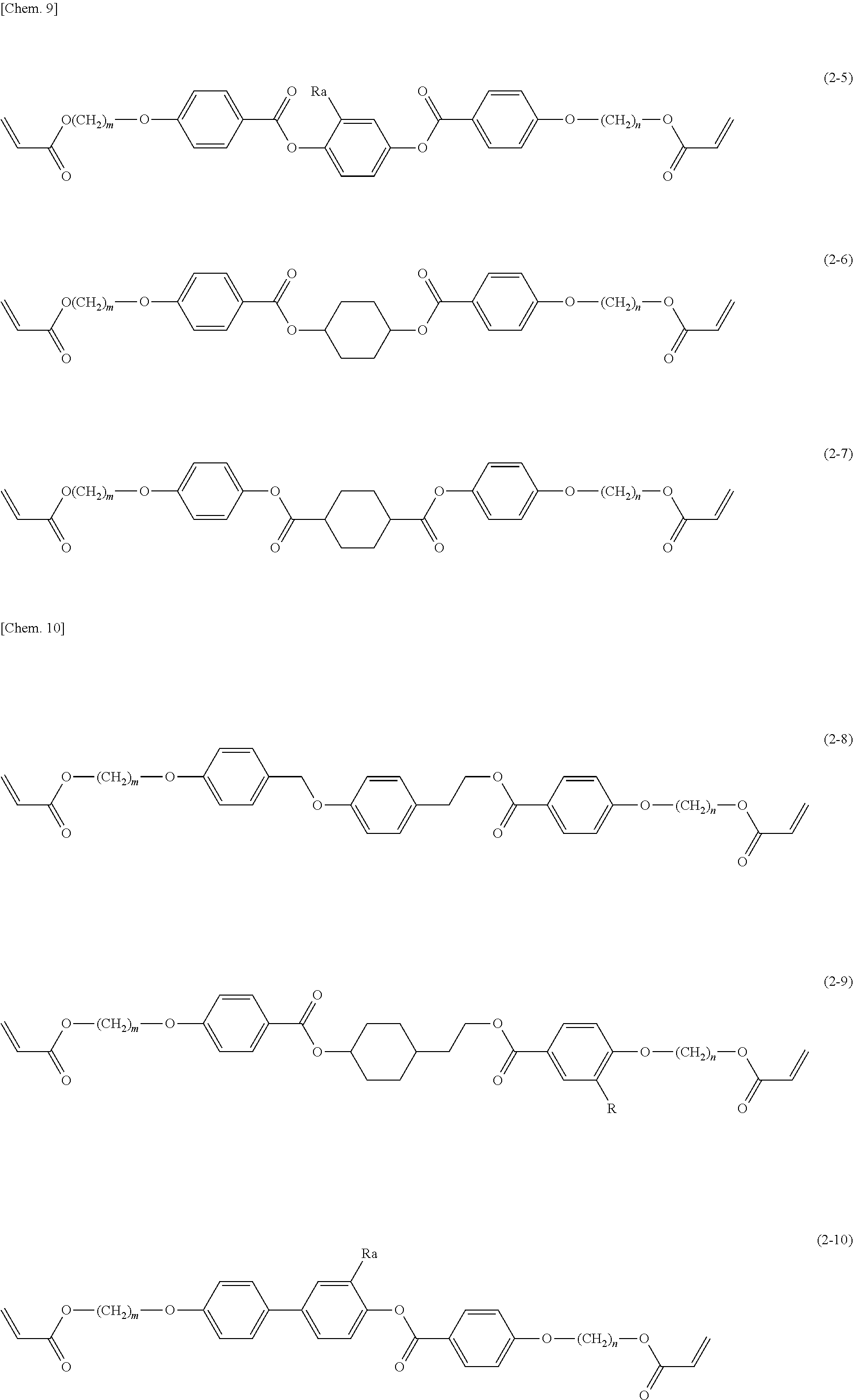

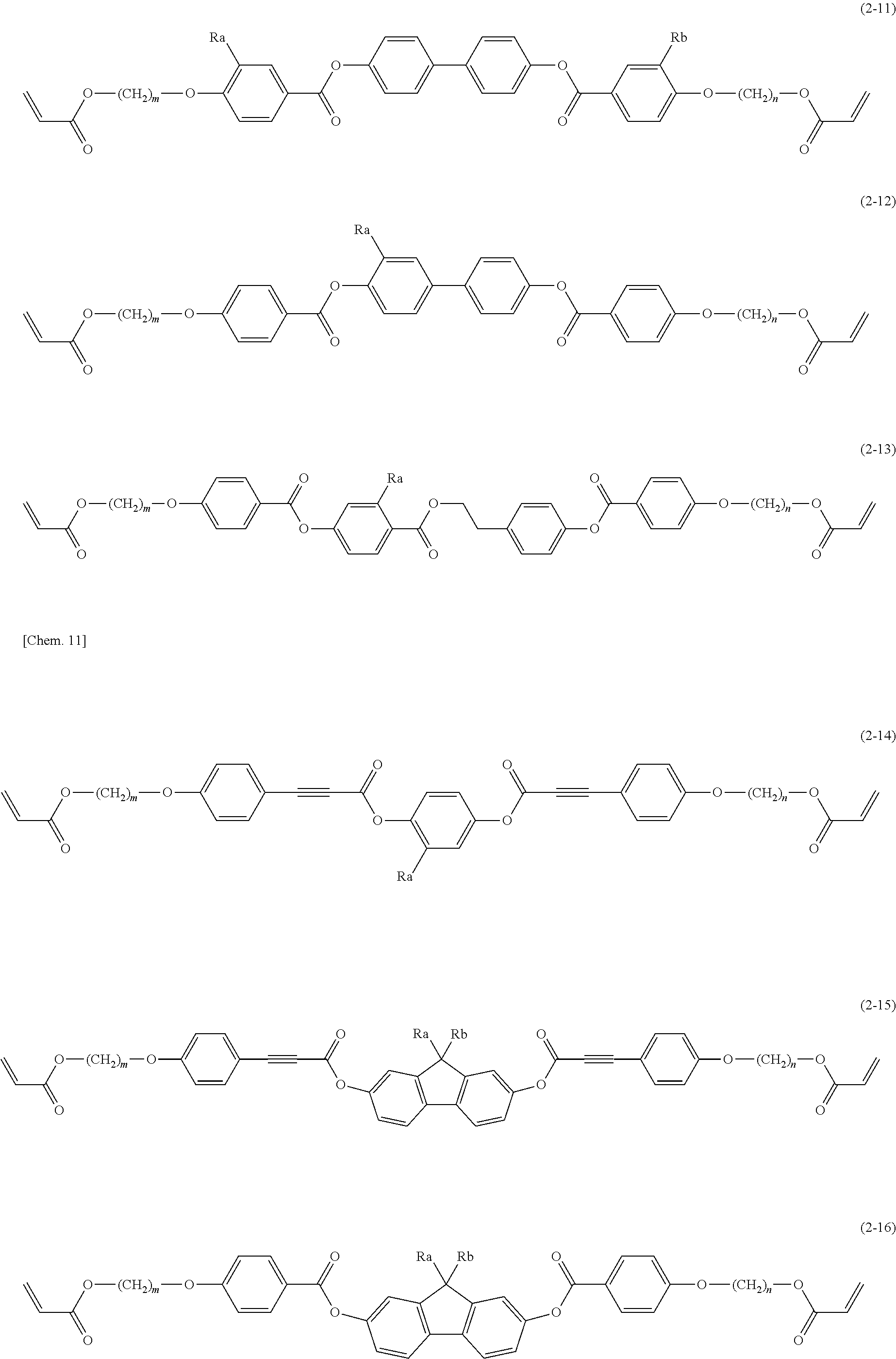

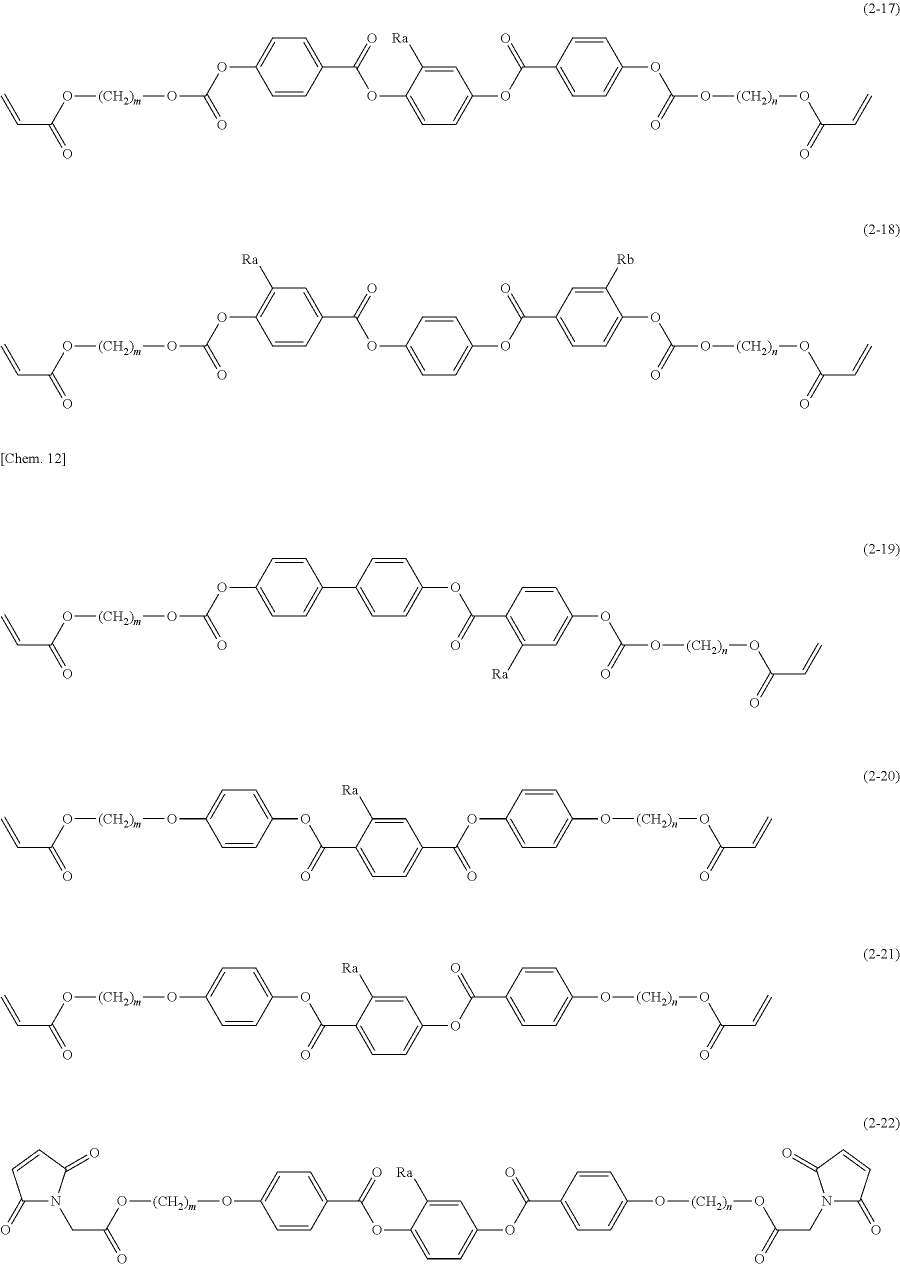

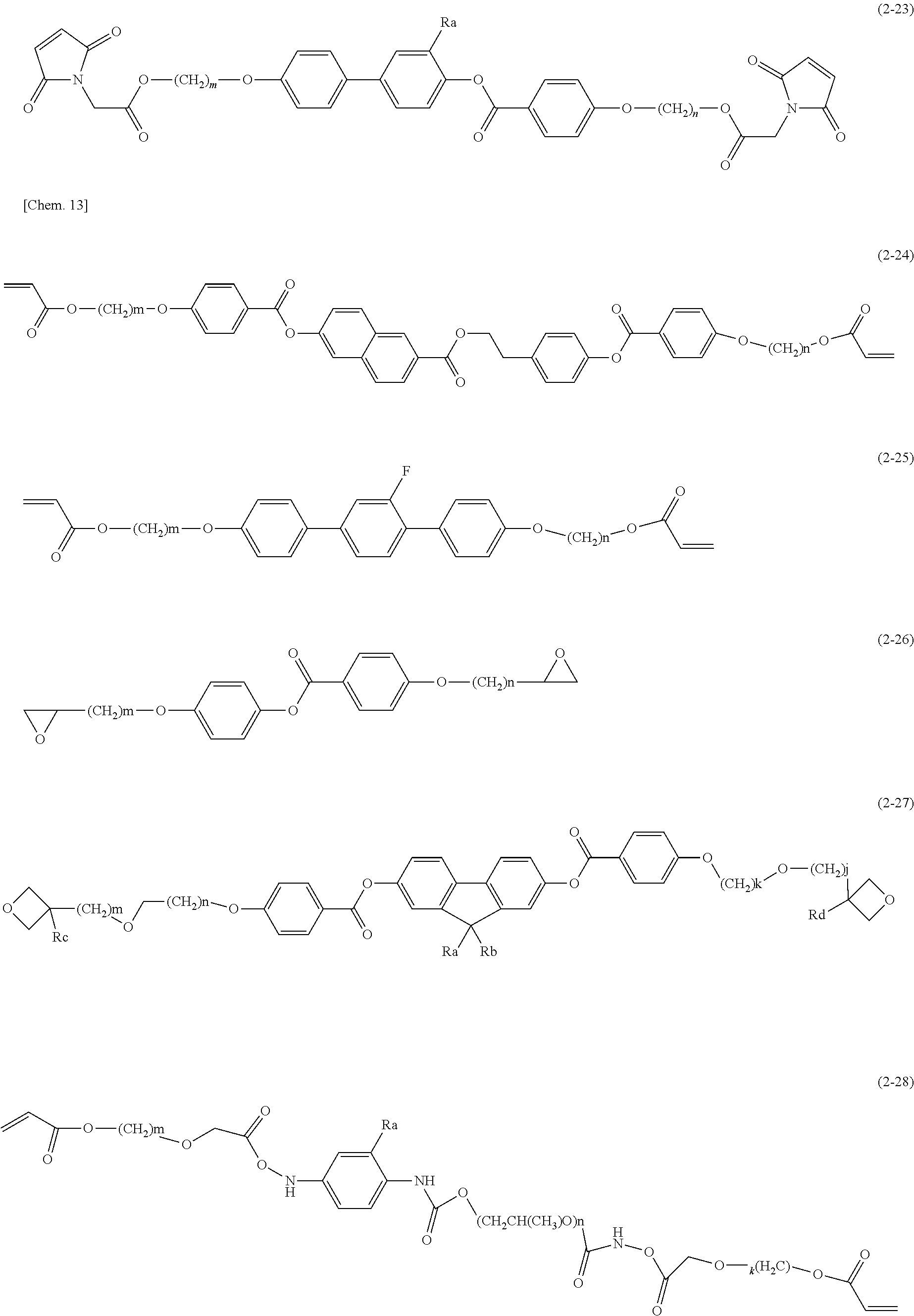

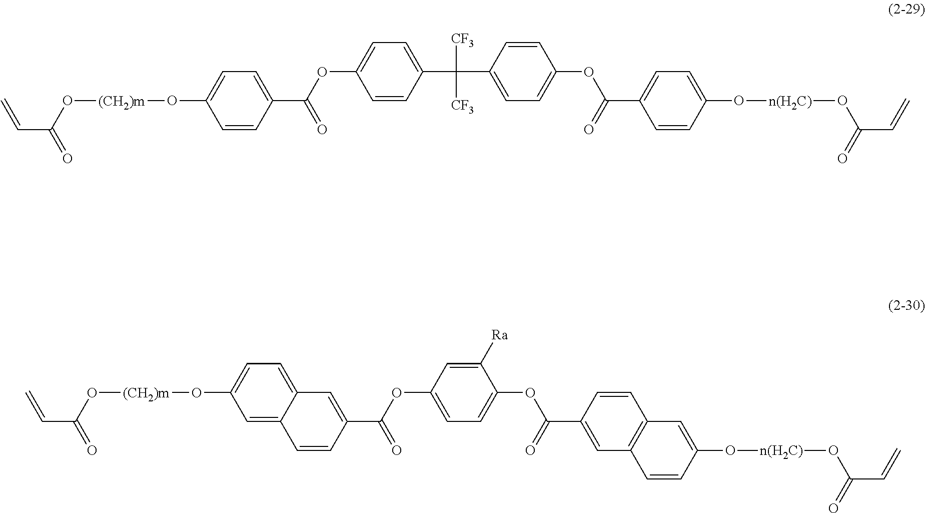

In the formulas, m, n, k, and j each independently represent an integer of 1 to 18, and Ra to Rd each independently represent a hydrogen atom, a halogen atom, an alkyl group having 1 to 6 carbon atoms, an alkoxy group having 1 to 6 carbon atoms, or a cyano group, but in a case where these groups are an alkyl group having 1 to 6 carbon atoms or an alkoxy group having 1 to 6 carbon atoms, all of the groups may be unsubstituted, or may be substituted by one or more of halogen atoms.

One or more liquid crystal compounds having two polymerizable functional groups may be used, but one to five liquid crystal compounds may be preferably used, and two to five liquid crystal compounds may be more preferably used.

The content of the liquid crystal compound having two or more polymerizable functional groups is preferably 5% to 100% by mass, more preferably 8% to 100% by mass, and particularly preferably 10% to 100% by mass in the polymerizable composition. In a case of emphasizing the rigidity of the optical anisotropic body, the lower limit value is preferably set to be 5% by mass or higher, more preferably 10% by mass or higher, and particularly preferably 20% by mass or higher, and, in a case of emphasizing low curing shrinkage, the upper limit value is preferably set to be 90% by mass or lower, and preferably 80% by mass or lower.

As the liquid crystal compound having two or more polymerizable functional groups, a compound having three polymerizable functional groups is also preferable. Formulas (3-1) to (3-18) may be exemplified, but the compound is not limited to the following Formulas.

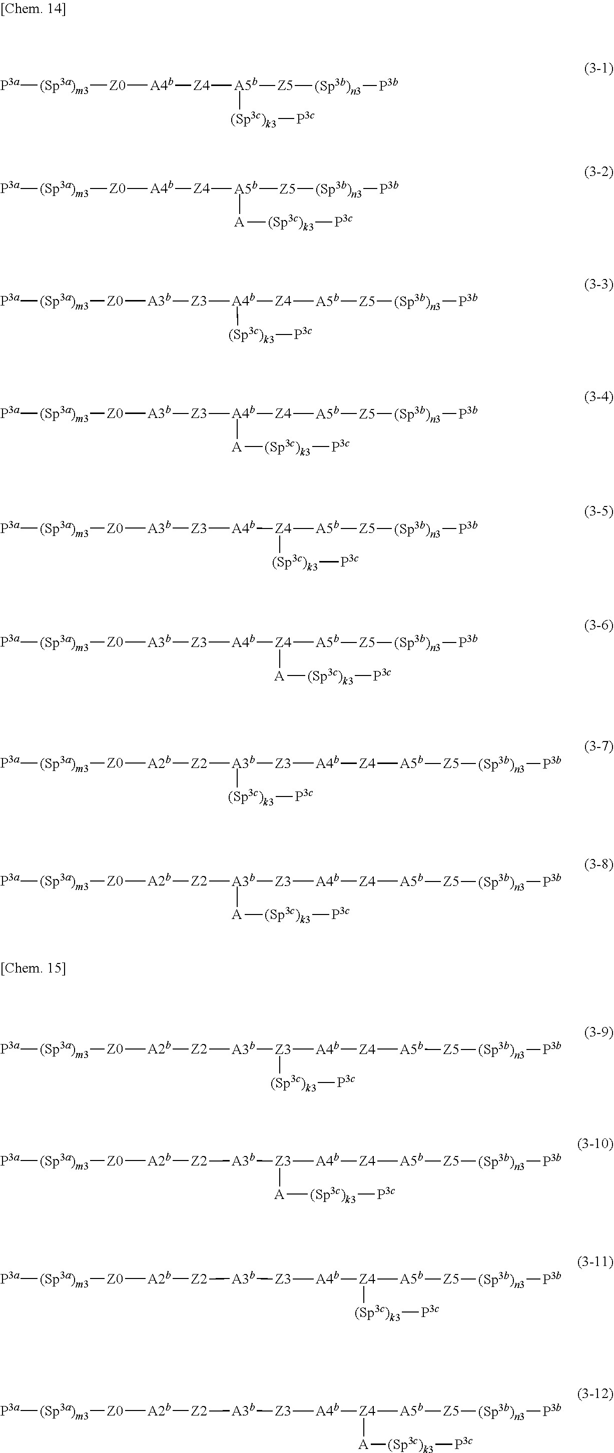

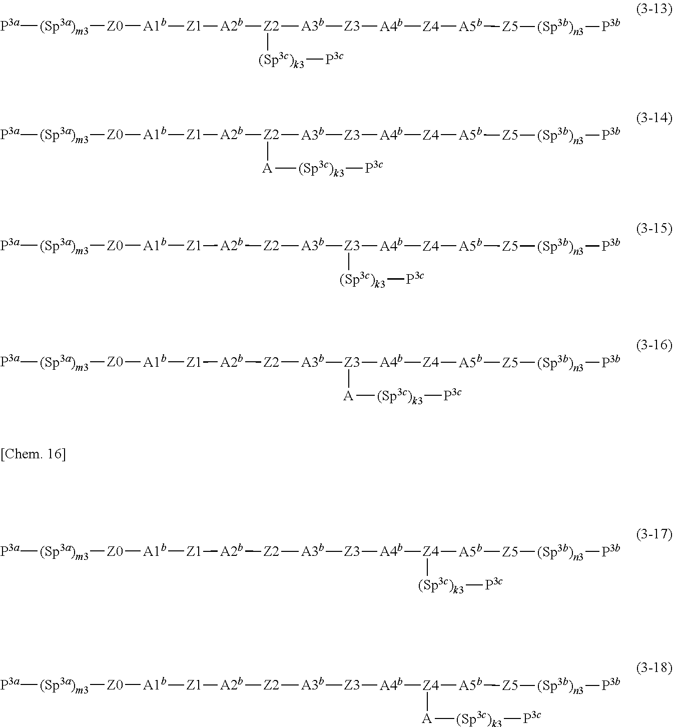

In the formulas, A1^{b}, A2^{b}, A3^{b}, A4^{b}, and A5^{b} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and

A1^{b}, A2^{b}, A3^{b}, A4^{b}, and A5^{b} may have, as substituents, one or more F, Cl, CF₃, OCF₃, and CN groups, an alkyl group, an alkoxy group, an alkanoyl group, or an alkanoyloxy group having 1 to 8 carbon atoms, an alkenyl group, an alkenyloxy group, an alkenoyl group, or an alkenoyloxy group having 2 to 8 carbon atoms.

In addition, Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond, and P^{3a}, P^{3b}, and P^{3c} each independently represent a polymerizable functional group, and Sp^{3a}, Sp^{3b}, and Sp^{3c} each independently represent an alkylene group having 0 to 18 carbon atoms (the alkylene group may be substituted by one or more of a halogen atom or CN, one of the CH₂ groups or two or more of the CH₂ groups which are not adjacent to each other present in the group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and A represents —O—, —COO—, —OCO—, —OCH₂—, —CH₂O—, —CH₂CH₂OCO—, —COOCH₂CH₂—, —OCOCH₂CH₂—, or a single bond. m3, n3, and k3 each independently represent 0 or 1.

Specific examples of the polymerizable liquid crystal compound having three polymerizable functional groups include compounds of Formulas (3-19) to (3-27), but the compound is not limited to the following compounds.

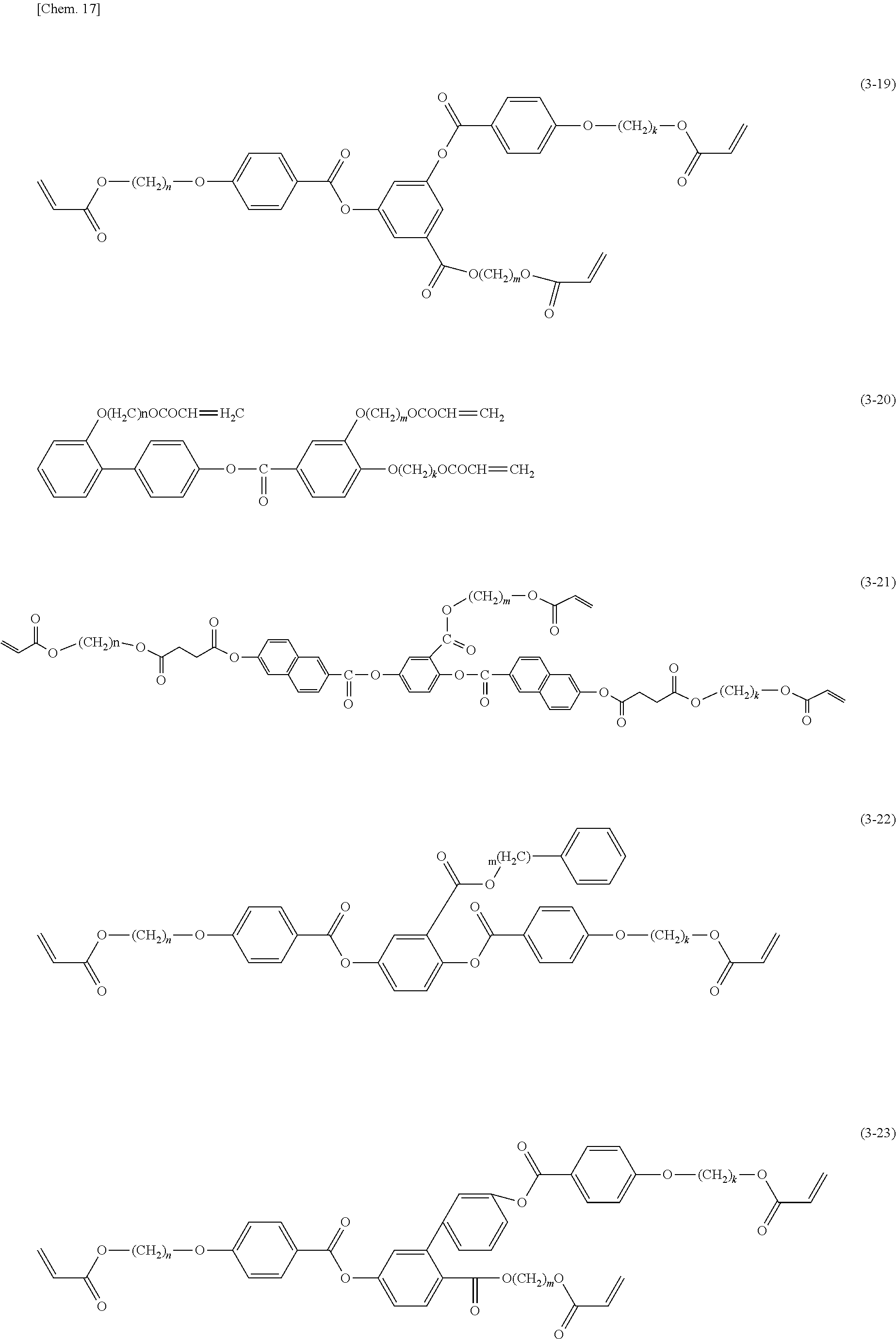

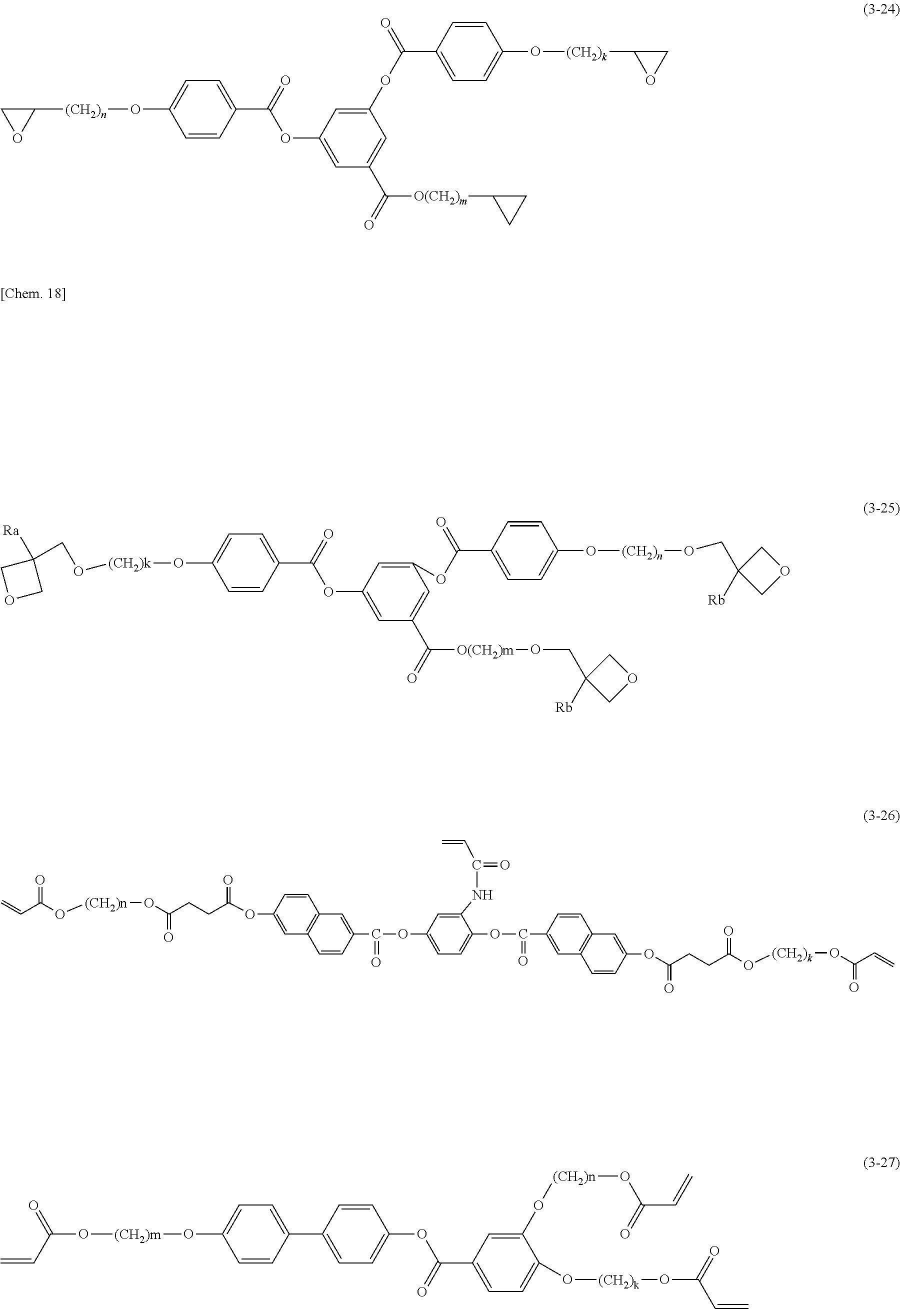

In the formulas, j, k, m and n each independently represent an integer of 0 to 18, but if oxygen atoms are directly bonded to each other in a case where j, k, m or n represents 0, one of the oxygen atoms is removed. Ra to Rc each independently represent a hydrogen atom, a halogen atom, an alkyl group having 1 to 6 carbon atoms, an alkoxy group having 1 to 6 carbon atoms, or a cyano group, and in a case where these groups are an alkyl group having 1 to 6 carbon atoms, or an alkoxy group having 1 to 6 carbon atoms, all of the groups may be unsubstituted, or may be substituted by one or more of halogen atoms.

One or more liquid crystal compounds having three polymerizable functional groups may be used, but one to four liquid crystal compounds may be preferably used, and one to three liquid crystal compounds may be more preferably used.

The content of the liquid crystal compound having three polymerizable functional groups is preferably 0% to 80% by mass, more preferably 0% to 70% by mass, and particularly preferably 0% to 60% by mass in the polymerizable liquid crystal composition. In a case of emphasizing rigidity of the optical anisotropic body, the lower limit value is preferably set to be 10% by mass or higher, more preferably 20% by mass or higher, and particularly preferably 30% by mass or higher, and, on the other hand, in a case of emphasizing low curing shrinkage, the upper limit value is preferably set to be 80% by mass or lower, more preferably 70% by mass or lower, and particularly preferably 60% by mass or lower.

The polymerizable liquid crystal composition of the present invention may contain a liquid crystal compound having one polymerizable functional group.

Specifically, the liquid crystal compound having one polymerizable functional group is preferably a compound represented by the following Formula (4).

[Chem. 19]

P⁴-(Sp⁴)ₘ₄-MG2-R⁴ (4)

In the formula, P⁴ represents a polymerizable functional group, Sp⁴ represents an alkylene group having 0 to 18 carbon atoms (the alkylene group may be substituted by one or more halogen atoms or CN, one of the CH₂ groups or two or more of the CH₂ groups which are not adjacent to each other present in the alkylene group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), m4 represents 0 or 1, MG2 represents a mesogenic group or a mesogenic supporting group, R⁴ represents a hydrogen atom, a halogen atom, a cyano group, or an alkyl group having 1 to 18 carbon atoms, the alkyl group may be substituted by one or more of a halogen atom or CN, and one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom.

P⁴ preferably represents a substituent selected from polymerizable groups represented by the following Formulas (P-1) to (P-20).

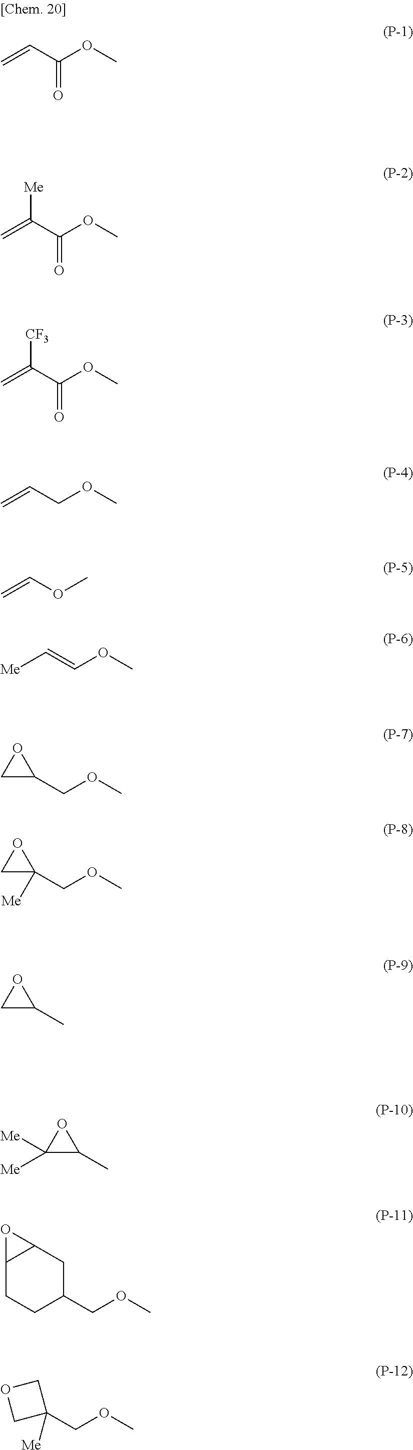

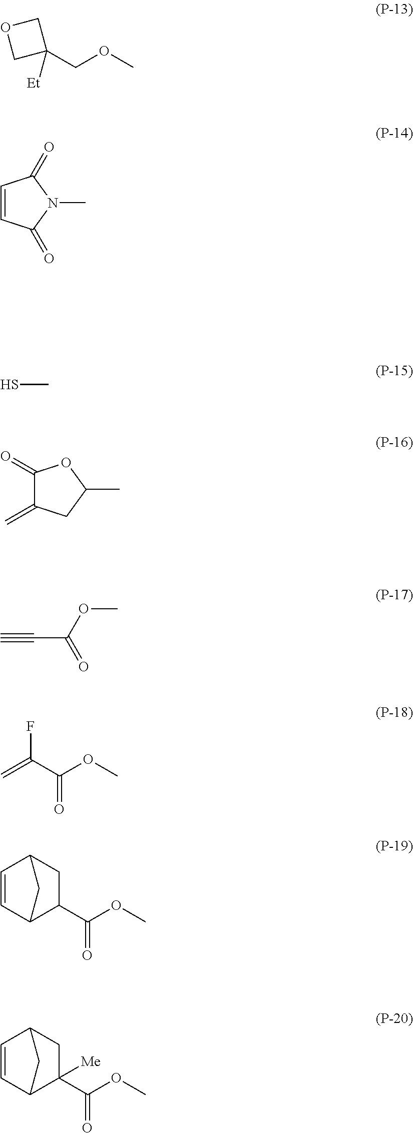

Among these polymerizable functional groups, Formula (P-1), Formula (P-2), (P-7), (P-12), or (P-13) is preferable, and Formula (P-1), Formula (P-2), (P-7), or (P-12) is more preferable, from the viewpoint of enhancing polymerizable properties and storage stability.

As the mesogenic group or the mesogenic supporting group represented by MG2, groups represented by Formula (4-b) are exemplified.

[Chem. 21]

—Z0^{c}-(A1^{c}-Z1^{c})_{pc}-(A2^{c}-Z2^{c})_{qc}-(A3^{c}-Z3^{c})_{rc}-A4^{c}-Z4^{c}-A5^{c}-Z5^{c}— (4-b)

In Formula (4-b), A1^{c}, A2^{c}, A3^{c}, A4^{c} and A5^{c} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and may have, as substituents, one or more F, Cl, CF₃, OCF₃, and CN groups, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, Z0^{c}, Z1^{c}, Z2^{c}, Z3^{c}, Z4^{c} and Z5^{c} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, and pc, qc and rc each independently represent 0 or 1, and satisfy 0≦pc+qc+rc≦3.

As an example of Formula (4), Formulas (4-1) to (4-4) may be exemplified, but Formula (4) is not limited to the following Formulas.

[Chem. 22]

P^{4a}-(Sp^{4a})ₘ₄-Z0^{c}-A4^{c}-Z4^{c}-A5^{c}-Z5^{c}-(Sp^{4b})ₙ₄-R⁴ (4-1)

P^{4a}-(Sp^{4a})ₘ₄-Z0^{c}-A3^{c}-Z3^{c}-A4^{c}-Z4^{c}-A5^{c}-Z5^{c}-(Sp^{4b})ₙ₄-R⁴ (4-2)

P^{4a}-(Sp^{4a})ₘ₄-Z0^{c}-A2^{c}-Z2^{c}-A3^{c}-Z3^{c}-A4^{c}-Z4^{c}-A5^{c}-Z5^{c}-(Sp^{4b})ₙ₄-R⁴ (4-3)

P^{4a}-(Sp^{4a})ₘ₄-Z0^{c}-A1^{c}-Z1^{c}-A2^{c}-Z2^{c}-A3^{c}-Z3^{c}-A4^{c}-Z4^{c}-A5^{c}-Z5^{c}-(Sp^{4b})ₙ₄-R⁴ (4-4)

In the formulas, A1^{c}, A2^{c}, A3^{c}, A4^{c}, and A5^{c} represent the same meaning as A1^{c}, A2^{c}, A3^{c}, A4^{c}, and A5^{c} in Formula (4-b). In addition, Z0^{c}, Z1^{c}, Z2^{c}, Z3^{c}, Z4^{c}, and Z5^{c} represent the same meaning as Z0^{c}, Z1^{c}, Z2^{c}, Z3^{c}, Z4^{c}, and Z5^{c} in Formula (4-b). Further, R⁴ represents the same meaning as R⁴ in Formula (4).

P^{4a} each independently represents a polymerizable functional group, Sp^{4a} and Sp^{4b} each independently represent an alkylene group having 0 to 18 carbon atoms (the alkylene group may be substituted by one or more of a halogen atom or CN, one of the CH₂ groups or two or more of the CH₂ groups which are not adjacent to each other present in the alkylene group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and m4 and n4 each independently represent 0 or 1.

As the compound represented by Formula (4), compounds represented by the following Formulas (4-5) to (4-43) are exemplified, but the compound is not limited thereto.

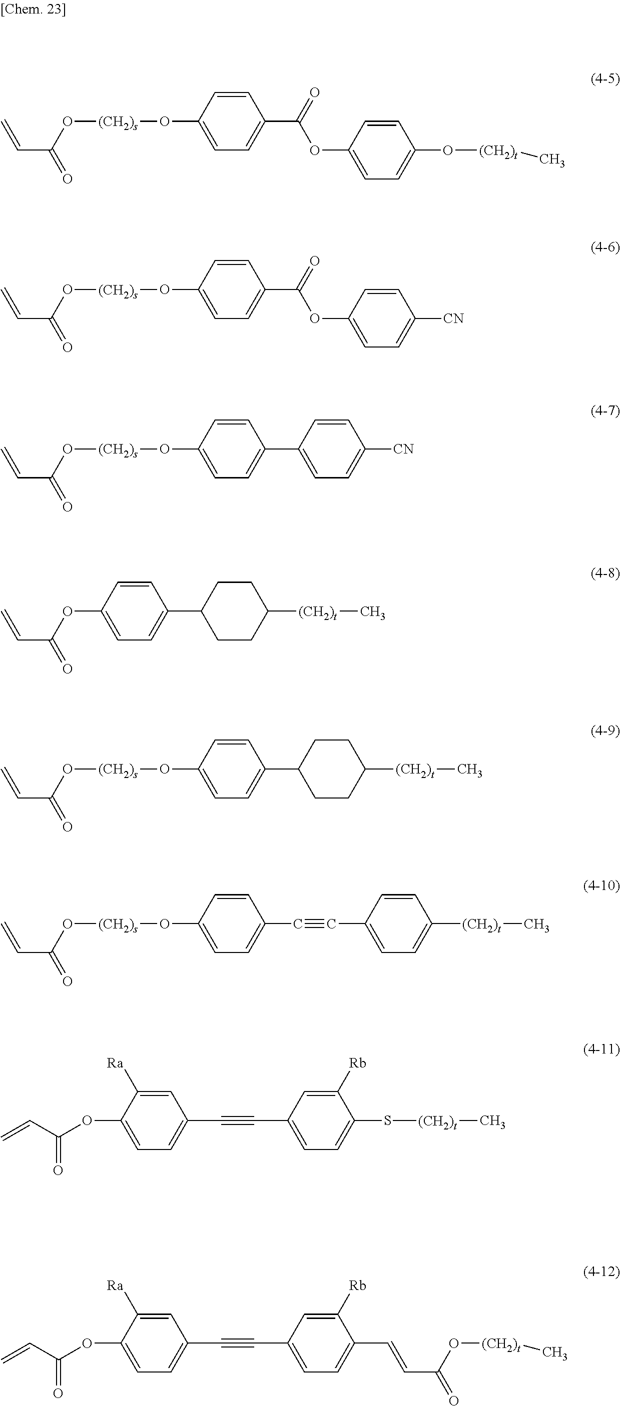

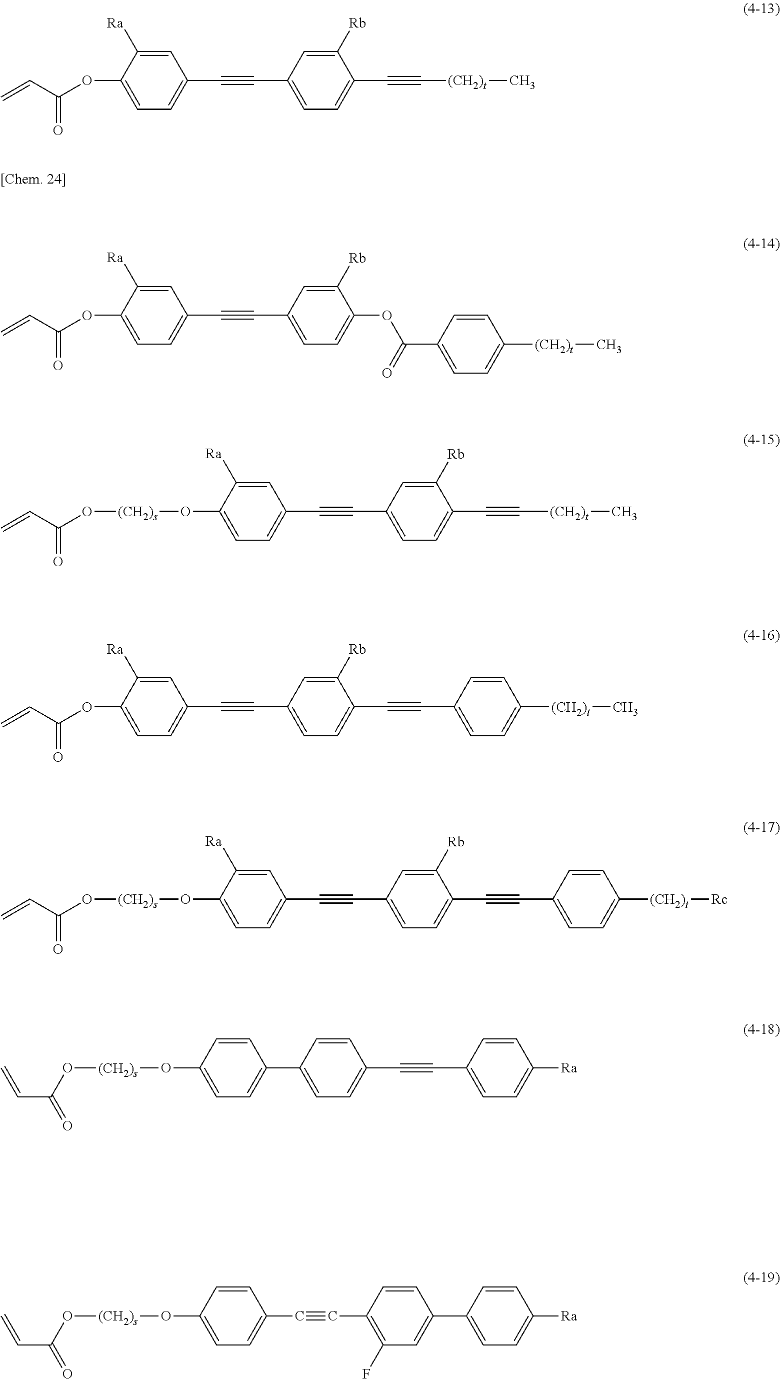

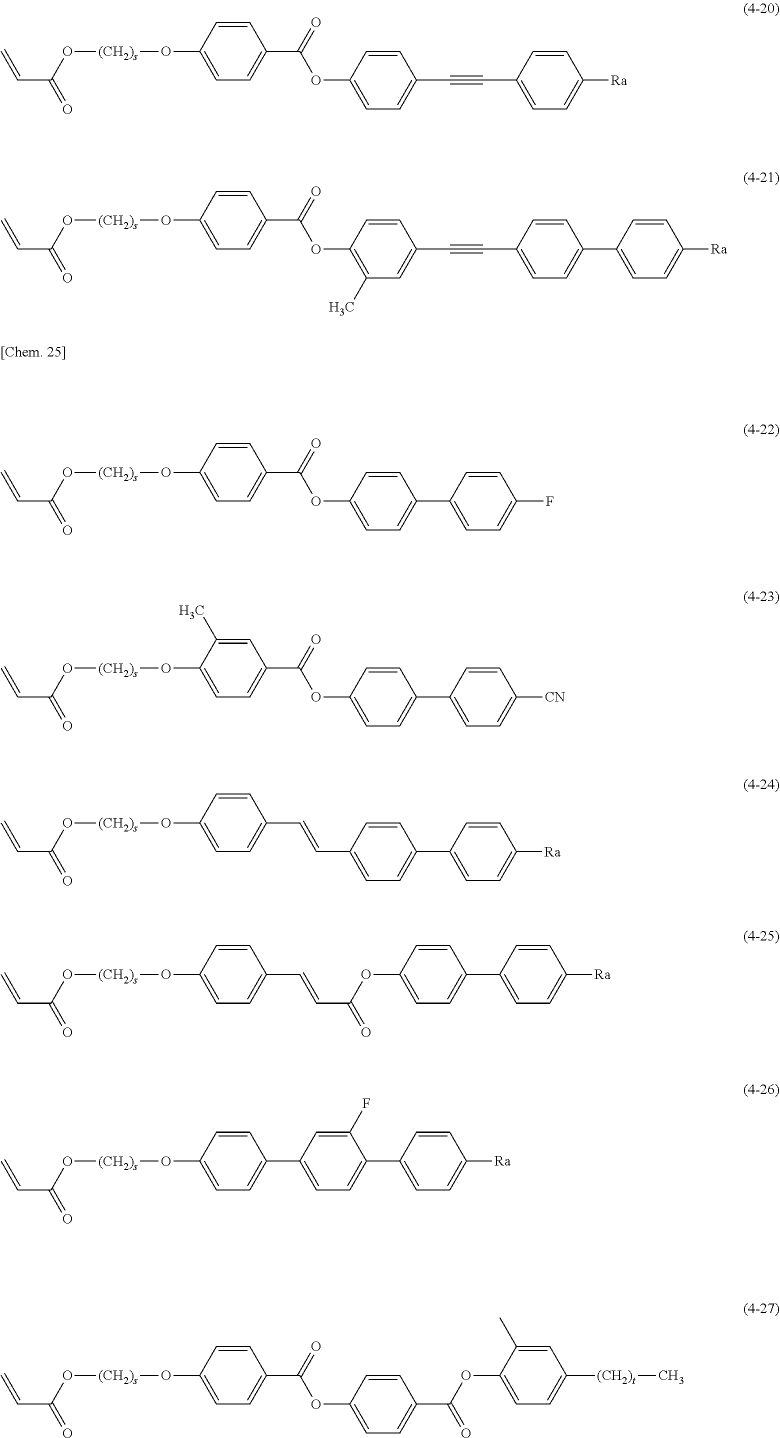

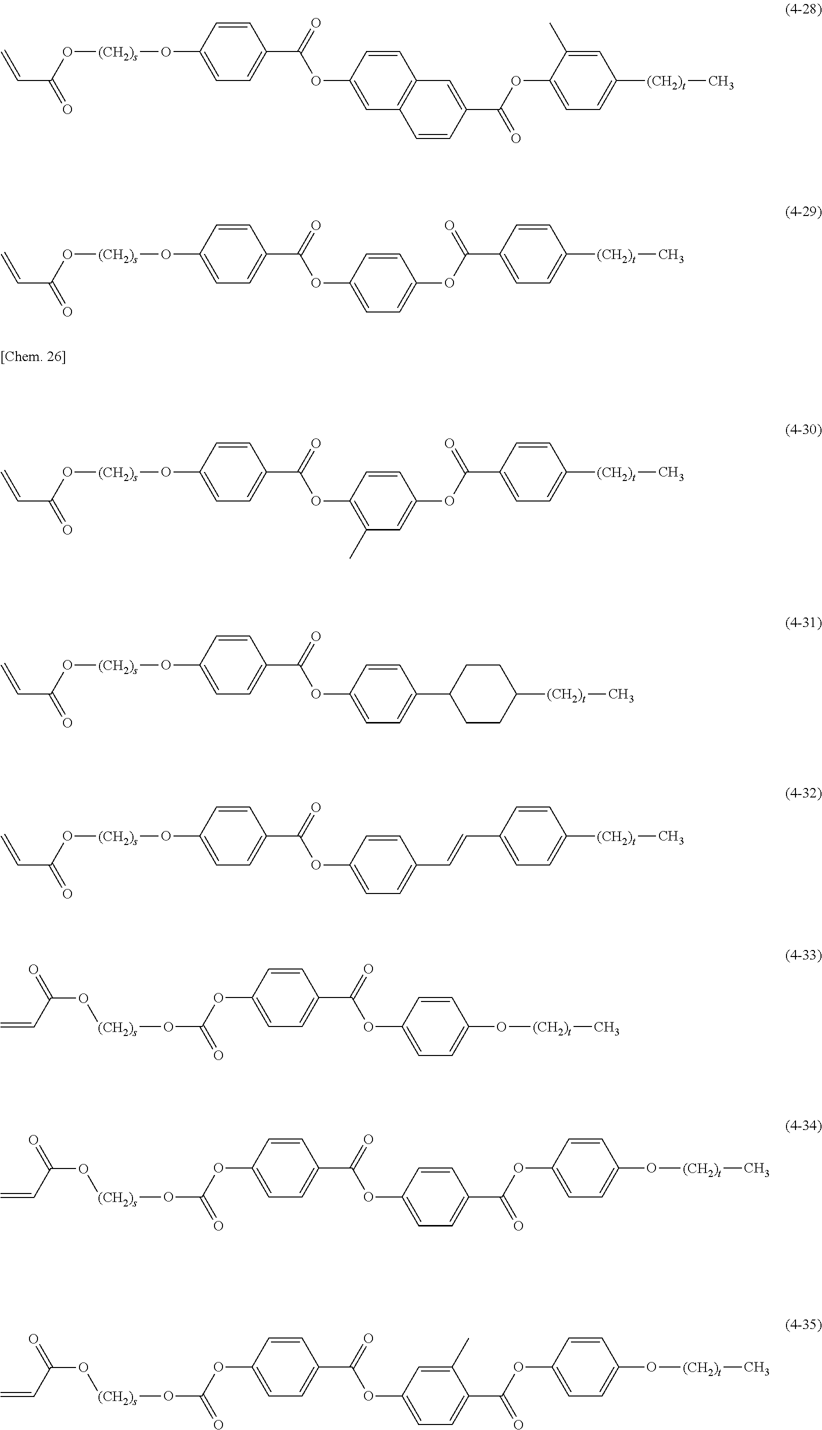

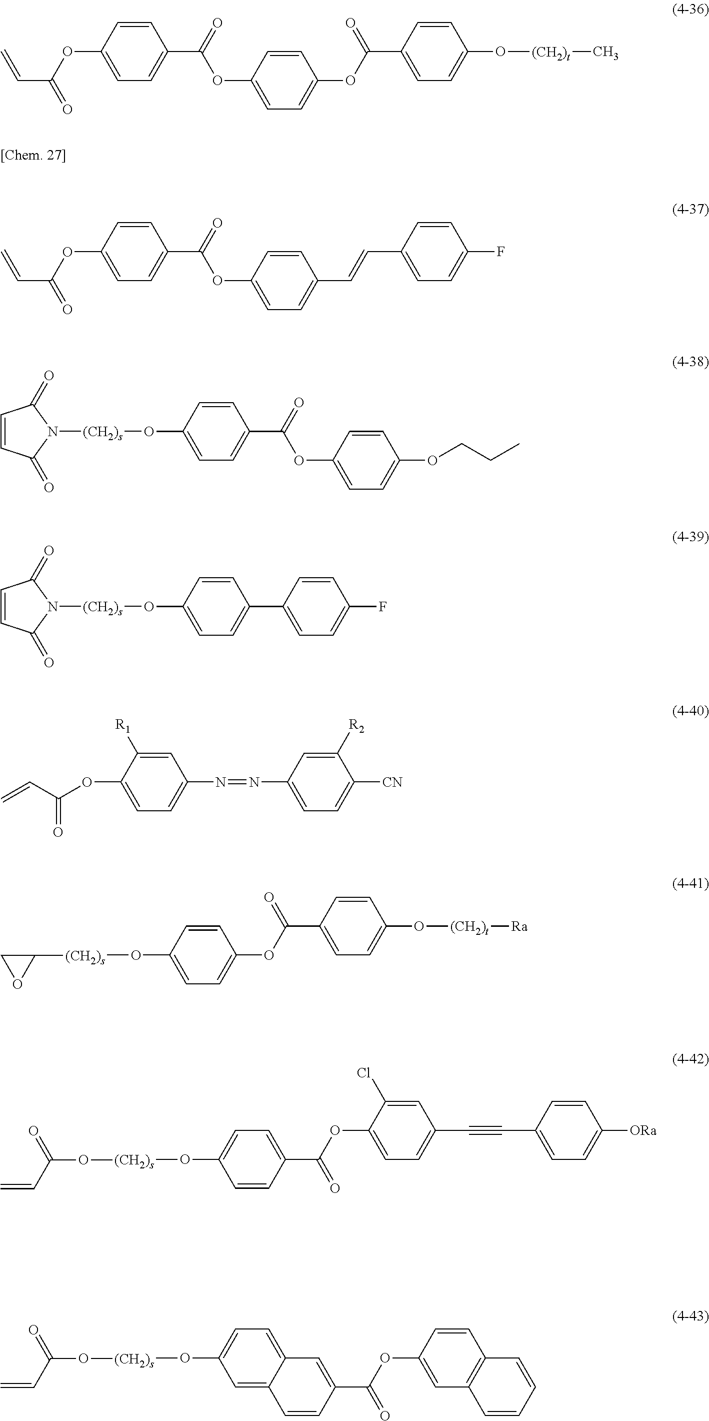

In the formulas, s and t represent an integer of 0 to 18, but if oxygen atoms are directly bonded to each other in a case where s or t represents 0, one of the oxygen atoms is removed. Ra, Rb, and Rc each independently represent a hydrogen atom, an alkyl group having 1 to 6 carbon atoms, an alkoxy group having 1 to 6 carbon atoms, a carboxyl group, or a cyano group, and in a case where these groups are an alkyl group having 1 to 6 carbon atoms, or an alkoxy group having 1 to 6 carbon atoms, all of the groups may be unsubstituted, or may be substituted by one or more of halogen atoms.

One or more liquid crystal compounds having one polymerizable functional group may be used, but one to five liquid crystal compounds may be preferably used, and one to four liquid crystal compounds may be more preferably used. The content of the liquid crystal compound having one polymerizable functional group is preferably 0% to 80% by mass, more preferably 10% to 80% by mass, and particularly preferably 20% to 80% by mass in the polymerizable liquid crystal composition. In a case of emphasizing alignment properties of the optical anisotropic body, the lower limit value is preferably set to be 10% by mass or higher and more preferably 20% by mass or higher, and, in a case of emphasizing rigidity, the upper limit value is preferably set to be 80% by mass or lower and more preferably 70% by mass or lower.

In addition, compounds containing a mesogenic group which does not have a polymerizable group may be added to the liquid crystal composition of the present invention, and compounds that are used in general liquid crystal device, for example, Super•Twisted•Nnematic (STN) liquid crystal, Twisted•Nematic (TN) liquid crystal, Thin Film Transistor (TFT) liquid crystal, and the like may be exemplified.

Specifically, the compound containing a mesogenic group which does not have a polymerizable functional group is preferably a compound represented by the following Formula (5).

[Chem. 28]

R⁵¹-MG3-R⁵¹ (5)

As the mesogenic group or the mesogenic supporting group represented by MG3, compounds represented by Formula (5-b) may be exemplified.

[Chem. 29]

—Z0^{d}-(A1^{d}-Z1^{d})ₙₑ-A2^{d}-Z2^{d}-A3^{d}-Z3^{d}— (5-b)

In the formula, A1^{d}, A2^{d}, and A3^{d} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group, 1,2,3, 4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and may have, as substituent, one or more F, Cl, CF₃, OCF₃, and CN groups, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, or an alkenoyloxy group, Z0^{d}, Z1^{d}, Z2^{d} and Z3^{d} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, n^{e} represents 0, 1 or 2, and R⁵¹ and R⁵² each independently represent a hydrogen atom, a halogen atom, a cyano group or an alkyl group having 1 to 18 carbon atoms, but the alkyl group may be substituted by one or more of a halogen atom or a CN group, and one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom.

Specifically, the compounds are shown below, but the compounds are not limited thereto.

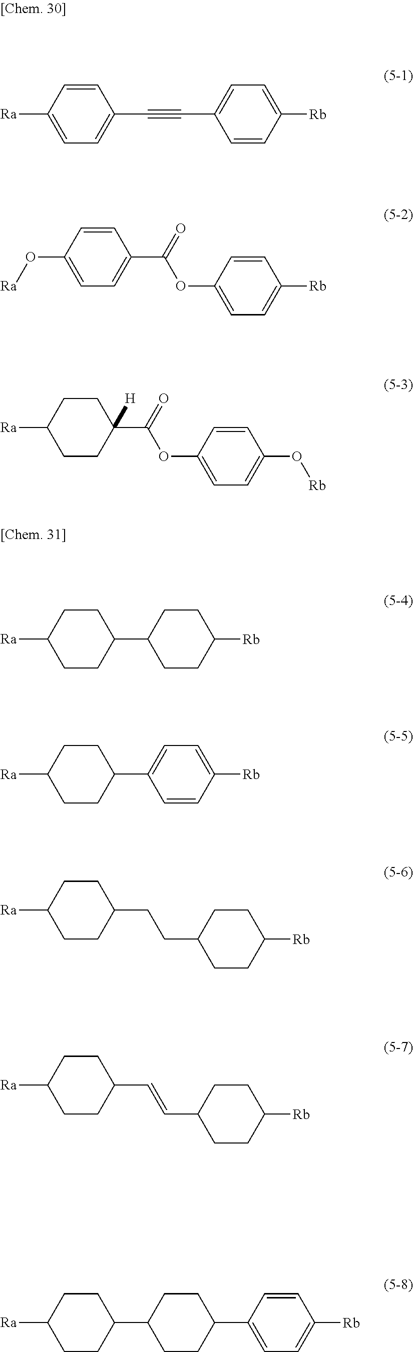

Rₐ and R_{b} each independently represent a hydrogen atom, an alkyl group having 1 to 6 carbon atoms, an alkoxy group having 1 to 6 carbon atoms, an alkenyl group having 1 to 6 carbon atoms, or a cyano group. The alkyl group having 1 to 6 carbon atoms or the alkoxy group having 1 to 6 carbon atoms may be unsubstituted or may be substituted by one or more of a halogen atom.

The total content of the compound represented by Formula (5) is preferably 5.0% by mass or higher, preferably 10.0% by mass or higher, and preferably 15.0% by mass or higher, and also, preferably 90.0% by mass or lower, and preferably 85.0% by mass or lower, based on the total amount of the polymerizable composition.

(Other Components)

(Chiral Compound)

The polymerizable liquid crystal composition of the present invention may be blended with a chiral compound for the purpose of obtaining a chiral nematic phase. Among the chiral compounds, compounds having a polymerizable functional group in the molecule are particularly preferable. Further, the chiral compounds of the present invention may be liquid crystalline, and may be non-liquid crystalline.

As the chiral compound used in the present invention, the compound having one or more polymerizable functional groups is preferable. Examples of such compounds include polymerizable chiral compounds containing chiral sugars such as isosorbide, isomannite, and glucoside, and a rigid site such as 1,4-phenylene group and 1,4-cyclohexylene group, and having a polymerizable functional group such as a vinyl group, an acryloyl group, a (meth)acryloyl group, or a maleimide group as described in JP-A-11-193287, JP-A-2001-158788, JP-T-2006-52669, JP-A-2007-269639, JP-A-2007-269640, JP-A-2009-84178, and the like, polymerizable chiral compounds consisting of terpenoid derivatives as described in JP-A-8-239666, polymerizable chiral compounds consisting of a spacer having a mesogenic group and a chiral site as described in NATURE VOL 35 pp. 467 to 469 (issued at Nov. 30, 1995), NATURE VOL 392 pp. 476 to 479 (issued at Apr. 2, 1998), and the like, or polymerizable chiral compounds containing a binaphthyl group as described in JP-T-2004-504285 and JP-A-2007-248945. Among the compounds, chiral compounds having large helical twisting power (HTP) are preferable for the polymerizable liquid crystal composition of the present invention.

The amount of the chiral compounds to be blended is required to be appropriately adjusted by the helical inducting power of the compound, but the amount is preferably 0% to 25% by mass, more preferably 0% to 20% by mass, and particularly preferably 0% to 15% by mass in the polymerizable liquid crystal composition.

As an example of Formula of chiral compounds, Formulas (6-1) to (6-4) may be exemplified, but the Formula is not limited to the following Formulas.

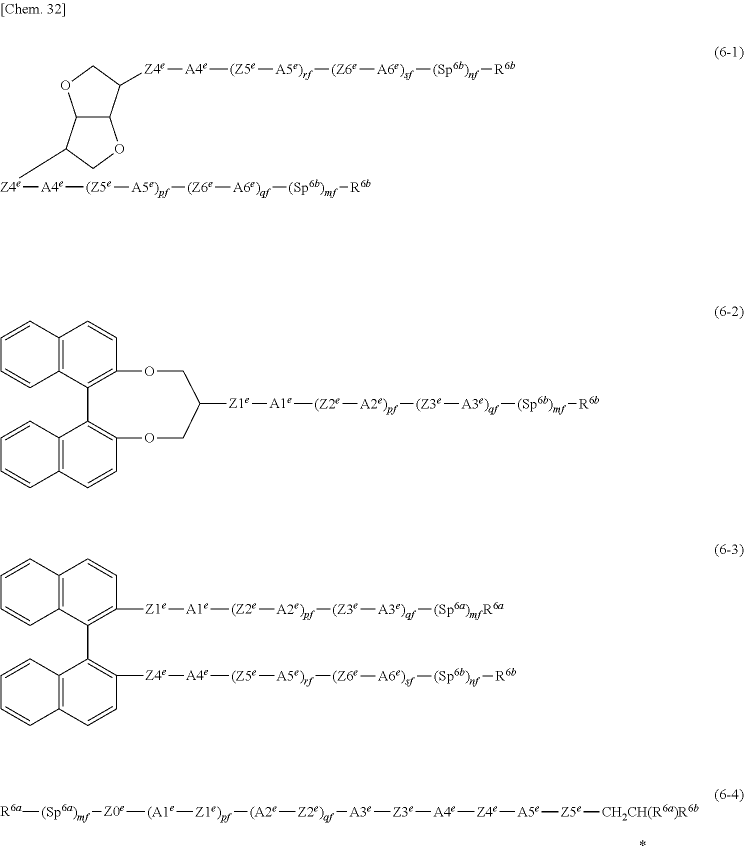

In the formulas, Sp^{6a} represents an alkylene group having 0 to 18 carbon atoms, and the alkylene group may be substituted by one or more halogen atoms, CN groups, or an alkyl group having 1 to 8 carbon atoms and having a polymerizable functional group, one of the CH₂ groups present in the group or two or more of the CH₂ groups which are not adjacent to each other may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom. A1^{e}, A2^{e}, A3^{e}, A4^{e}, and A5^{e} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, pf, qf, rf and sf each independently represent 0 or 1, and satisfy 0≦pf+qf+rf+sf≦3, Z1^{e}, Z2^{e}, Z3^{e}, Z4^{e}, Z5^{e} and Z6^{e} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, mf and nf represent 0 or 1, and

R^{6a} and R^{6b} represent a hydrogen atom, a halogen atom, a cyano group or an alkyl group having 1 to 18 carbon atoms, but the alkyl group may be substituted by one or more of a halogen atom or CN, one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom, or R^{6a} and R^{6b} are represented by Formula (6-a) below.

[Chem. 33]

-P^{6a} (6-a)

P^{6a} preferably represents substituents selected from polymerizable groups represented by the following Formulas (P-1) to (P-20).

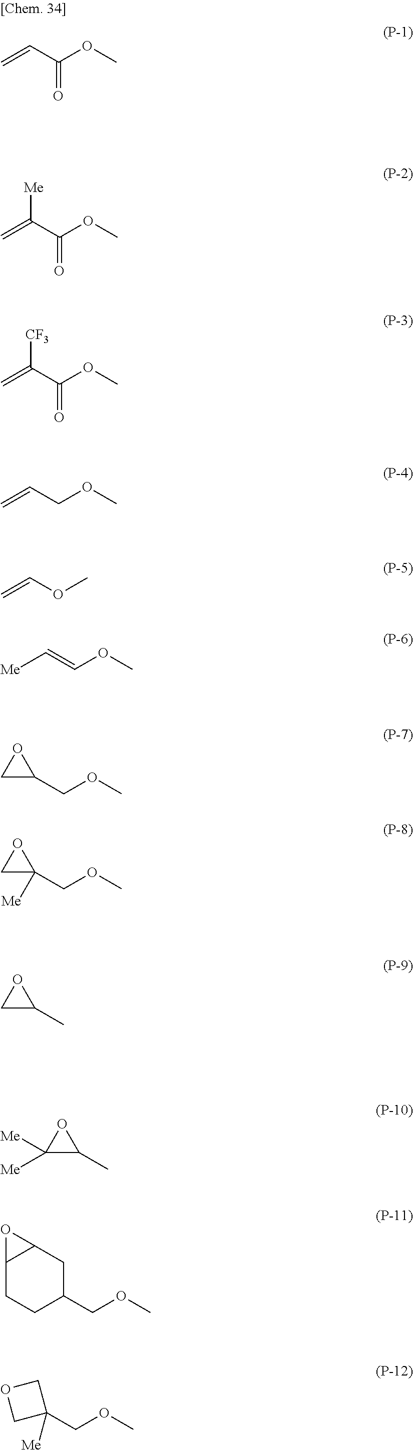

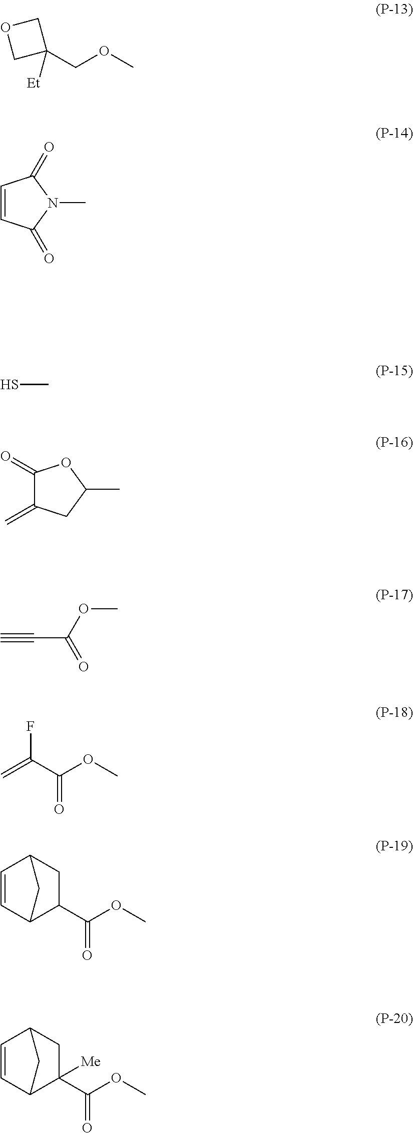

Among these polymerizable functional groups, Formula (P-1), Formula (P-2), Formula (P-7), Formula (P-12), or Formula (P-13) is preferable, and Formula (P-1), Formula (P-2), Formula (P-7), or Formula (P-12) is more preferable, from the viewpoint of enhancing polymerizable properties and storage stability.

Specific examples of the chiral compound may include compounds (6-5) to (6-32), but the compound is not limited to the following compounds.

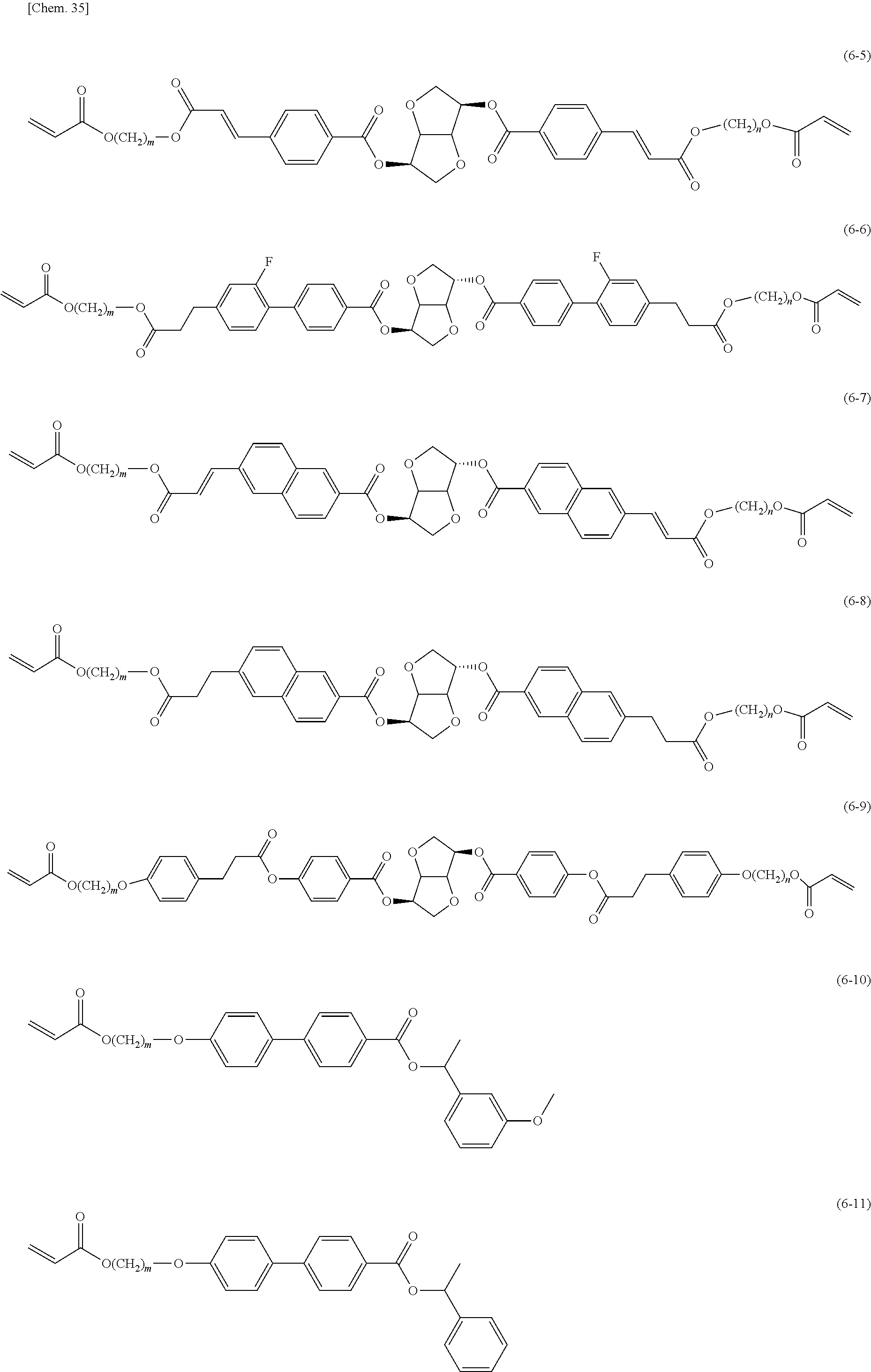

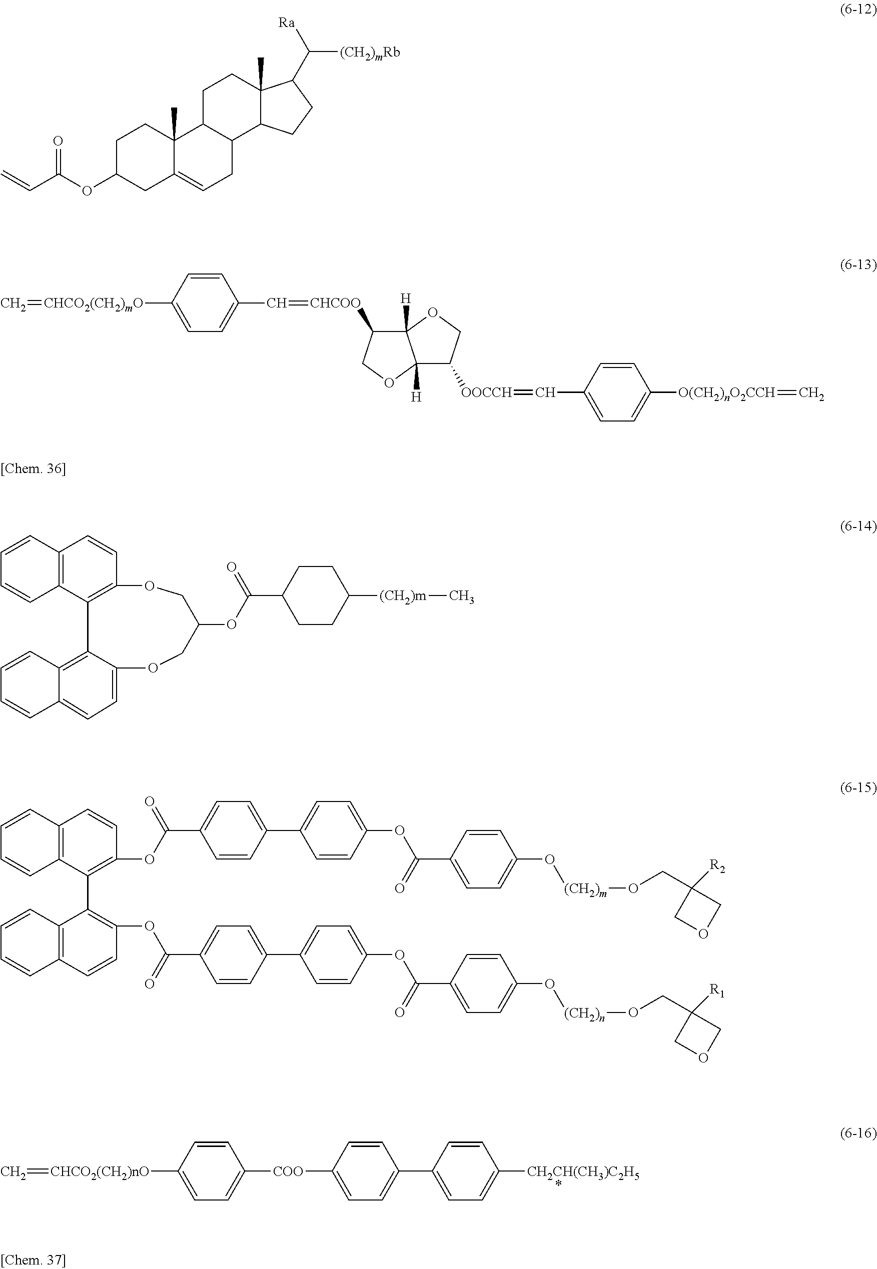

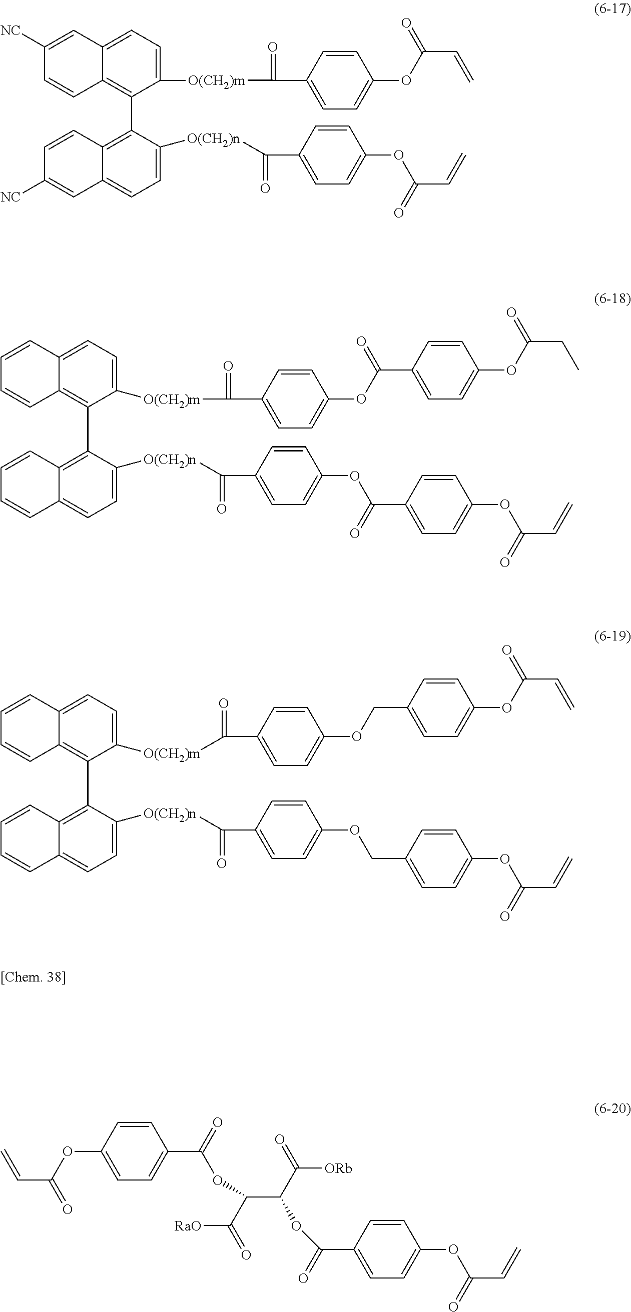

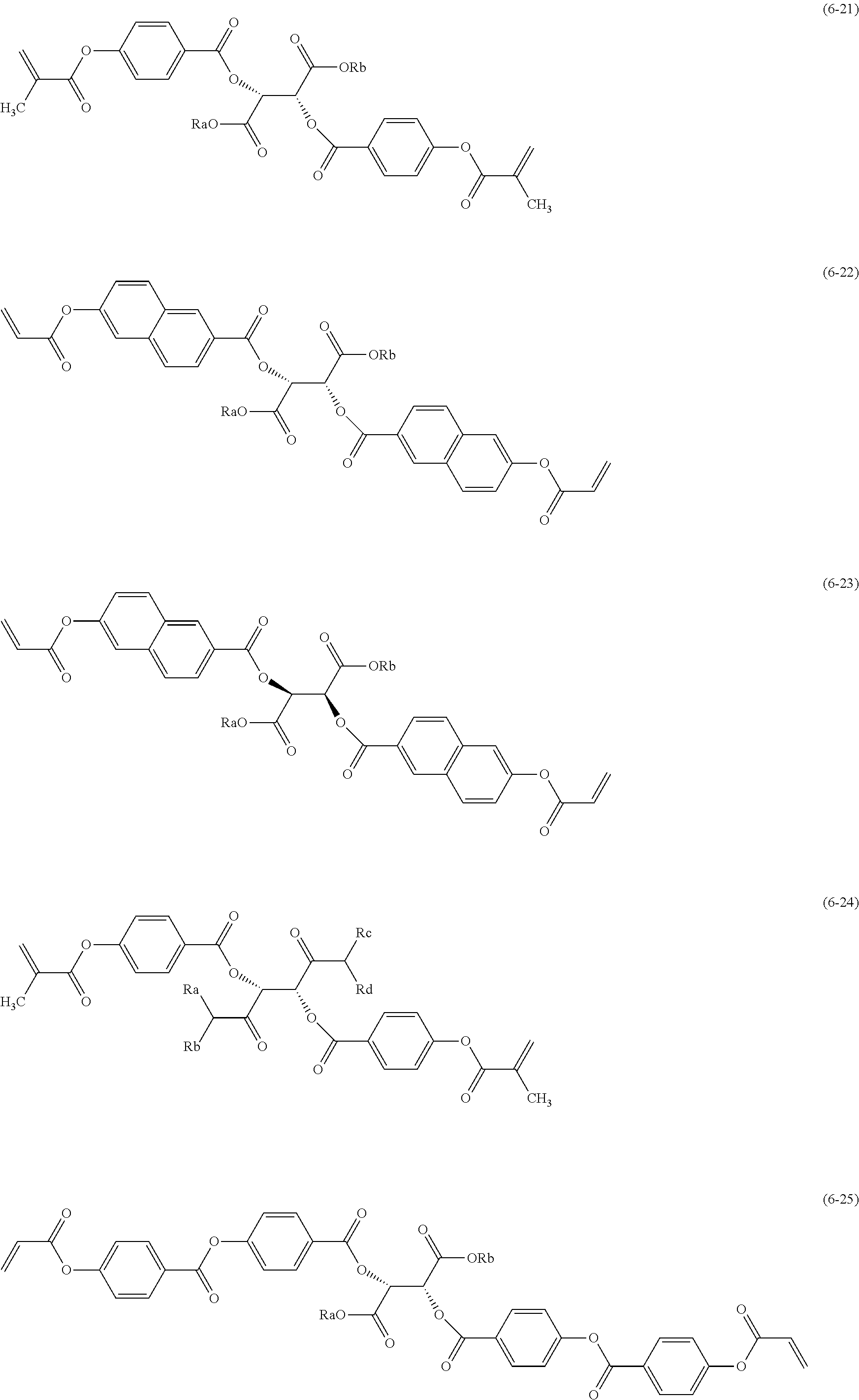

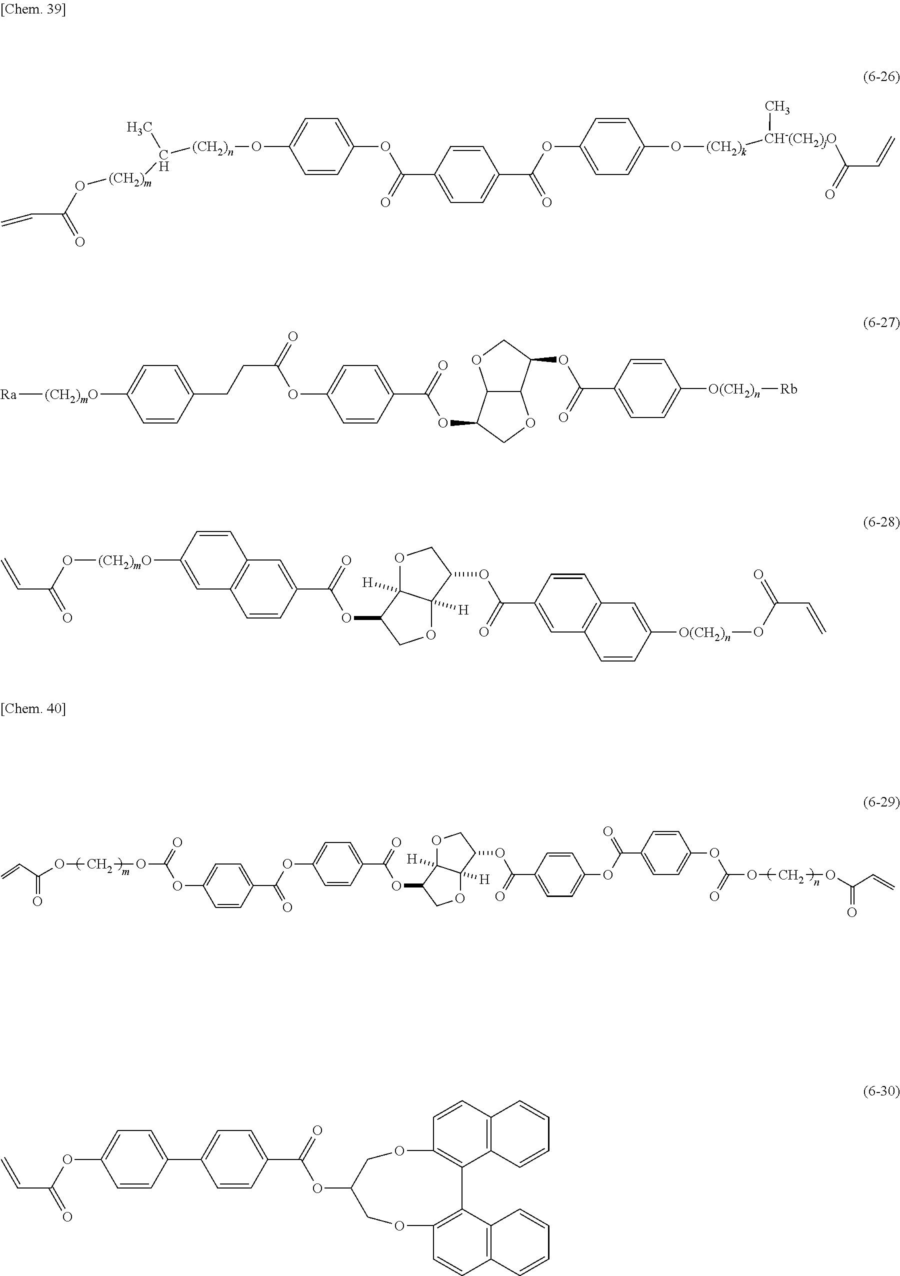

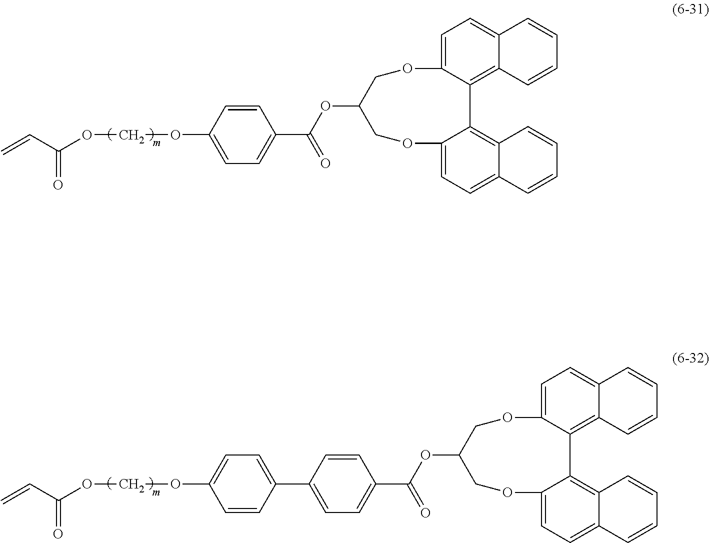

In the formulas, m, n, k, and j each independently represent an integer of 1 to 18, and Rₐ to R_{d} each independently represent a hydrogen atom, an alkyl group having 1 to 6 carbon atoms, an alkoxy group having 1 to 6 carbon atoms, a carboxyl group, or a cyano group. In a case where these groups are an alkyl group having 1 to 6 carbon atoms, or an alkoxy group having 1 to 6 carbon atoms, all of the groups may be unsubstituted, or may be substituted by one or more of halogen atoms.

(Organic Solvents)

Organic solvents may be added to the composition of the present invention. The organic solvent used is not particularly limited, but the organic solvent by which the polymerizable compound exhibits good solubility is preferable, and the organic solvent which can be dried at 100° C. or lower is preferable. Examples of such solvents include aromatic hydrocarbons such as toluene, xylene, cumene, and mesitylene, ester solvents such as methyl acetate, ethyl acetate, propyl acetate, and butyl acetate, ketone solvents such as methyl ethyl ketone, methyl isobutyl ketone, cyclohexanone, and cyclopentanone, ether solvents such as tetrahydrofuran, 1,2-dimethoxyethane, and anisole, amide solvents such as N,N-dimethylformamide, and N-methyl-2-pyrrolidone, propylene glycol monomethyl ether acetate, diethylene glycol monomethyl ether acetate, γ-butyrolactone and chlorobenzene, and the like. These solvents may be used alone, or may be used in a combination of two or more thereof, but it is preferable to use any one or more of ketone solvents, ether solvents, ester solvents and aromatic hydrocarbon solvents from the viewpoint of solution stability.

When the composition used in the present invention is used as a solution of an organic solvent, the composition may be applied to the substrate, the ratio of the organic solvent used is not specifically limited as long as the organic solvent does not significantly impair the state of applied, but the total amount of the organic solvent contained in the composition solution is preferably 1% to 60% by mass, more preferably 3% to 55% by mass, and particularly preferably 5% to 50% by mass.

When dissolving the composition in an organic solvent, it is preferable to perform heating and stirring in order to uniformly dissolve the composition. The heating temperature during heating and stirring may be adjusted as appropriate in consideration of the solubility of the composition in an organic solvent to be used, but the temperature is preferably from 15° C. to 110° C., more preferably from 15° C. to 105° C., even more preferably from 15° C. to 100° C., and particularly preferably from 20° C. to 90° C. from the viewpoint of productivity.

In addition, when adding a solvent, it is preferable to perform stirring and mixing by a dispersion stirrer. Specifically, as the dispersion stirrer, dispersers having DISPAR, a propeller, a stirring blade like a turbine blade, or the like, a paint shaker, a planetary stirrer, a shaking apparatus, a shaker, a rotary evaporator, or the like may be used. Other ultrasonic irradiation apparatuses may be used.

The stirring rotational speed during adding the solvent is preferably appropriately adjusted by the stirrer used, but the stirring rotational speed is set to be preferably 10 rpm to 1000 rpm, more preferably 50 rpm to 800 rpm, and particularly preferably 150 rpm to 600 rpm to form a uniform polymerizable composition solution.

(Polymerization Inhibitors)

It is preferable to add a polymerization inhibitor in the polymerizable composition of the present invention. Examples of the polymerization inhibitors include phenolic compounds, quinone compounds, amine compounds, thioether compounds, nitroso compounds, and the like.

Examples of phenolic compounds include p-methoxyphenol, cresol, t-butylcatechol, 3,5-di-t-butyl-4-hydroxytoluene, 2,2′-methylenebis(4-methyl-6-t-butylphenol), 2,2′-methylenebis(4-ethyl-6-t-butylphenol), 4,4′-thiobis(3-methyl-6-t-butylphenol), 4-methoxy-1-naphthol, 4,4′-dialkoxy-2,2′-bi-1-naphthol, and the like.

Examples of quinone compounds include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, diphenoquinone, and the like.

Examples of the amine compounds include p-phenylenediamine, 4-aminodiphenylamine, N,N′-diphenyl-p-phenylenediamine, N-i-propyl-N′-phenyl-p-phenylenediamine, N-(1,3-dimethylbutyl)-N′-phenyl-p-phenylenediamine, N,N′-di-2-naphthyl-p-phenylenediamine, diphenylamine, N-phenyl-β-naphthylamine, 4,4′-dicumyl-diphenylamine, 4,4′-dioctyl-diphenylamine, and the like.

Examples of the thioether compounds include phenothiazine, distearyl thiodipropionate, and the like.

Examples of the nitroso-based compounds include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, or the like, N,N-dimethylp-nitrosoaniline, p-nitrosodiphenylamine, nitronedimethylamine, p-nitrone-N,N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4,6-tri-tert-butylnitronebenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenol hydrochloride, 2-nitroso-5-methylaminophenol hydrochloride, and the like.

The amount of the polymerization inhibitor added is preferably 0.01% to 1.0% by mass and more preferably 0.05% to 0.5% by mass based on the polymerizable composition.

(Antioxidants)

Antioxidants or the like may be added to enhance the stability of the polymerizable composition of the present invention. Examples of such compounds include hydroquinone derivatives, nitrosamine-based polymerization inhibitors, hindered phenol-based antioxidants, or the like, and more specific examples thereof include tert-butylhydroquinone, methylhydroquinone, “Q-1300”, and “Q-1301” manufactured by Wako Pure Chemical Industries, Ltd., pentaerythritol tetrakis[3-(3,5-di-tert-butyl-4-hydroxyphenyl)propionate “IRGANOX1010”, thiodiethylenebis[3-(3,5-di-tert-butyl-4-hydroxyphenyl)propionate “IRGANOX1035”, octadecyl-3-(3,5-di-tert-butyl-4-hydroxyphenyl)propionate “IRGANOX1076”, “IRGANOX1098”, “IRGANOX1135”, “IRGANOX1330”, 4,6-bis(octylthiomethyl)-o-cresol “IRGANOX1520L”, “IRGANOX1425”, “IRGANOX1726”, “IRGANOX245”, “IRGANOX259”, “IRGANOX3114”, “IRGANOX3790”, “IRGANOX5057”, and “IRGANOX565” (manufactured by BASF SE), ADK STAB AO-20, AO-30, AO-40, AO-50, AO-60, and AO-80 manufactured by ADEKA CORPORATION, SUMILIZER BHT, SUMILIZER BBM-S, and SUMILIZER GA-80 manufactured by Sumitomo Chemical Co., Ltd., and the like.

The amount of the antioxidant added is preferably 0.01% to 2.0% by mass and more preferably 0.05% to 1.0% by mass based on the polymerizable composition.

(Photopolymerization Initiator)

The polymerizable composition of the present invention preferably contains a photopolymerization initiator. At least one or more photopolymerization initiators are preferably contained. Specific examples thereof include 1-hydroxycyclohexylphenylketone “IRGACURE184”, 2-hydroxy-2-methyl-1-phenyl-propan-1-one “DAROCUR1173”, 1-(4-isopropylphenyl)-2-hydroxy-2-methylpropan-1-one “DAROCUR1116”, 2-methyl-1-[(methylthio)phenyl]-2-morpholinopropan-1 “IRGACURE907”, 2-hydroxy-1-{4-[4-(2-hydroxy-2-methyl-propionyl)-benzyl)phenyl]-2-methyl-propan-1-one “IRGACURE127”, 2,2-dimethoxy-1,2-diphenylethan-1-one “IRGACURE651”, 2-benzyl-2-dimethylamino-1-(4-morpholinophenyl)-butanone “IRGACURE369”), 2-dimethylamino-2-(4-methylbenzyl)-1-(4-morpholino-phenyl)butan-1-one “IRGACURE379”, 2,2-dimethoxy-1,2-diphenylethan-1-one, bis(2,4,6-trimethylbenzoyl)-diphenylphosphine oxide “LUCIRIN TPO”, 2,4,6-trimethylbenzoyl-phenyl-phosphine oxide “IRGACURE819”, 1-[4-(2-hydroxyethoxy)-phenyl]-2-hydroxy-2-methyl-1-propan-1-one “IRGACURE2959”, a mixture of bis(2,6-dimethoxybenzoyl)-2,4,4-trimethylpentylphosphine oxide, and 1-hydroxycyclohexylphenylketone (1:3) “IRGACURE1800”, iodonium{4-(2-methylpropyl)phenyl}(hexafluorophosphate) “IRGACURE250”, a mixture of oxyphenylacetic acid, 2-[2-oxo-2-phenylacetoxy ethoxy]ethylester and oxyphenylacetic acid, 2-(2-hydroxyethoxy)ethylester “IRGACURE754”, bis(eta 5-2,4-cyclopentadiene-1-yl)-bis(2,6-difluoro-3-(1H-pyrrol-1-yl)-phenyl) titanium “IRGACURE784”, (1,2-dioxo-2-methoxyethyl)benzene “DAROCUR MBF” 1,2-octanedione, 1-[4-(phenylthio)-, 2-(O-benzoyloxime)] “IRGACURE OXE01”, 1-[9-ethyl-6-(2-methylbenzoyl)-9H-carbazol-3-yl]-, 1-(O-acetyl oxime) “IRGACURE OXE02” (manufactured by BASF SE), a mixture of 2,4-diethylthioxanthone (“KAYACURE DETX” manufactured by NIPPON KAYAKU Co., Ltd.) and p-dimethylaminobenzoic acid ethyl (“KAYACURE EPA” manufactured by NIPPON KAYAKU Co., Ltd.), para dimethylbenzoic acid isoamyl ester (“KAYACURE DMBI” manufactured by NIPPON KAYAKU Co., Ltd.), a mixture of isopropylthioxanthone (“QUANTACURE ITX” manufactured by Ward Blenkinsop and Co Ltd.) and p-dimethylamino benzoic acid ethyl, “ESACURE ONE”, “ESACURE KIP150”, “ESACURE KIP160”, “ESACURE 1001M”, “ESACURE A198”, “ESACURE KIP IT”, “ESACURE KTO46”, and “ESACURE TZT” (manufactured by Lamberti S.p.A.), “SPEEDCURE BMS”, “SPEEDCURE PBZ”, “SPEEDCURE BEM”, “SPEEDCURE MBP”, “SPEEDCURE MBB”, “SPEEDCURE ITX”, “SPEEDCURE DETX”, and “SPEEDCURE EBD” manufactured by Lambson Limited, “benzophenone”, and “TAZ-A” manufactured by Japan Siber Hegner Co., Ltd. (currently DKSH Japan K.K.), “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919” manufactured by ADEKA CORPORATION, and the like. Moreover, as the cationic photoinitiator, a photoacid generator may be used. Examples of the photoacid generator include diazodisulfone-based compounds, triphenylsulfonium-based compounds, phenylsulfone-based compounds, sulfonyl pyridine-based compounds, triazine-based compounds and diphenyl iodonium compounds, and the like.

The amount of the photopolymerization initiator used is preferably 0.1% to 10% by mass and particularly preferably 0.5% to 5% by mass based on the polymerizable composition. These initiators may be used alone, or may be used as a mixture of two or more thereof. Further, a sensitizer, and the like may also be added.

(Thermal Polymerization Initiator)

A thermal polymerization initiator may be used together with a photopolymerization initiator in the polymerizable composition of the present invention. As the thermal polymerization initiator used during the thermal polymerization, the known conventional initiators may be used, but specific examples thereof include alkyl peroxide compounds such as “PERHEXYL D”, and “PERHEXYL I” manufactured by Nippon Oil & Fats Co., Ltd. (currently NOF CORPORATION), organic peroxides such as methyl acetoacetate peroxide, cumene hydroperoxide, benzoyl peroxide, bis(4-t-butylcyclohexyl) peroxydicarbonate, t-butyl peroxy benzoate, methyl ethyl ketone peroxide, 1,1-bis(t-hexylperoxy) 3,3,5-trimethylcyclohexane, p-penta hydroperoxide, t-butyl hydroperoxide, dicumyl peroxide, isobutyl peroxide, di(3-methyl-3-methoxy-butyl) peroxydicarbonate, and 1,1-bis (t-butylperoxy) cyclohexane, azonitrile compounds such as 2,2′-azobisisobutyronitrile, and 2,2′-azobis(2,4-dimethyl valeronitrile), azoamidine compounds such as 2,2′-azobis (2-methyl-N-phenylpropione-amidine) dihydrochloride, azoamide compounds such as 2,2′azobis {2-methyl-N-[1,1-bis (hydroxymethyl)-2-hydroxyethyl]propionamide}, alkylazo compounds such as 2,2′azobis (2,4,4-trimethyl pentane), 1,1′azobis (cyclohexane-1-carbonitrile) of “V-40” manufactured by Wako Pure Chemical Industries, Ltd., and 2,2′-azobis [N-(2-propenyl)-2-methyl propionamide] of “VF-096” manufactured by Wako Pure Chemical Industries, Ltd., and the like.

The amount of the thermal polymerization initiator used is preferably 0.1% to 10% by mass, and particularly preferably 0.5% to 5% by mass based on the polymerizable composition. These initiators may be used alone, or may be used as a mixture of two or more thereof.

(Surfactant)

The polymerizable composition of the present invention may contain at least one or more surfactants in order to reduce the thickness irregularity in a case of being an optical anisotropic body. Examples of the surfactant which may be contained include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkyl ethylene oxide derivatives, polyethylene glycol derivatives, alkyl ammonium salts, fluoroalkyl ammonium salts, and the like, and fluorine-containing surfactants are particularly preferred.

Specific examples thereof include “MEGAFAC F-110”, “MEGAFACF-113”, “MEGAFAC F-120”, “MEGAFAC F-812”, “MEGAFAC F-142D”, “MEGAFAC F-144D”, “MEGAFAC F-150”, “MEGAFAC F-171”, “MEGAFACF-173”, “MEGAFAC F-177”, “MEGAFAC F-183”, “MEGAFAC F-195”, “MEGAFAC F-824”, “MEGAFAC F-833”, “MEGAFAC F-114”, “MEGAFAC F-410”, “MEGAFAC F-493”, “MEGAFAC F-494”, “MEGAFAC F-443”, “MEGAFAC F-444”, “MEGAFAC F-445”, “MEGAFAC F-446”, “MEGAFAC F-470”, “MEGAFAC F-471”, “MEGAFAC F-474”, “MEGAFAC F-475”, “MEGAFAC F-477”, “MEGAFAC F-478”, “MEGAFAC F-479”, “MEGAFAC F-480SF”, “MEGAFAC F-482”, “MEGAFAC F-483”, “MEGAFAC F-484”, “MEGAFAC F-486”, “MEGAFAC F-487”, “MEGAFAC F-489”, “MEGAFAC F-172D”, “MEGAFAC F-178K”, “MEGAFAC F-178RM”, “MEGAFAC R-08”, “MEGAFAC R-30”, “MEGAFAC F-472SF”, “MEGAFAC BL-20”, “MEGAFAC R-61”, “MEGAFAC R-90”, “MEGAFAC ESM-1”, and “MEGAFAC MCF-350SF” (manufactured by DIC Corporation),

“FTERGENT 100”, “FTERGENT 100C”, “FTERGENT 110”, “FTERGENT 150”, “FTERGENT 150CH”, “FTERGENT A”, “FTERGENT 100A-K”, “FTERGENT 501”, “FTERGENT 300”, “FTERGENT 310”, “FTERGENT 320”, “FTERGENT 400SW”, “FTX-400P”, “FTERGENT 251”, “FTERGENT 215M”, “FTERGENT 212MH”, “FTERGENT 250”, “FTERGENT 222F”, “FTERGENT 212D”, “FTX-218”, “FTX-209F”, “FTX-213F”, “FTX-233F”, “FTERGENT 245F”, “FTX-208G”, “FTX-240G”, “FTX-206D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FTX-750LL”, “FTX-730LS”, “FTX-730LM”, “FIX-730LL”, and “FTX-710LL” (manufactured by NEOS COMPANY LIMITED), “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, and “BYK-Silclean3700” (manufactured by BYK Additives & Instruments), “TEGO Rad 2100”, “TEGO Rad 2200N”, “TEGO Rad 2250”, “TEGO Rad 2300”, “TEGO Rad 2500”, “TEGO Rad 2600”, “TEGO Rad 2650”, “TEGO Rad 2700”, “TEGO Flow 300”, “TEGO Flow 370”, “TEGO Flow 425”, “TEGO Flow ATF 2”, “TEGO Flow ZFS 460”, “TEGO Glide 100”, “TEGO Glide 110”, “TEGO Glide 130”, “TEGO Glide 410”, “TEGO Glide 411”, “TEGO Glide 415”, “TEGO Glide 432”, “TEGO Glide 440”, “TEGO Glide 450”, “TEGO Glide 482”, “TEGO Glide A115”, “TEGO Glide B1484”, “TEGO Glide ZG400”, “TEGO Twin 4000”, “TEGO Twin 4100”, “TEGO Twin 4200”, “TEGO Wet 240”, “TEGO Wet 250”, “TEGO Wet 260”, “TEGO Wet 265”, “TEGO Wet 270”, “TEGO Wet 280”, “TEGO Wet 500”, “TEGO Wet 505”, “TEGO Wet 510”, “TEGO Wet 520”, and “TEGO Wet KL245” (manufactured by EVONIK INDUSTRIES AG), “UNIDYNE NS” (manufactured by DAIKIN INDUSTRIES, LTD.), “SURFLON S-241”, “SURFLON S-242”, “SURFLON S-243”, “SURFLON S-420”, “SURFLON S-611”, “SURFLON S-651”, and “SURFLON S-386” (manufactured by AGC SEIMI CHEMICAL CO., LTD.), “DISPARLON OX-880EF”, “DISPARLON OX-881”, “DISPARLON OX-883”, “DISPARLON OX-77EF”, “DISPARLON OX-710”, “DISPARLON 1922”, “DISPARLON 1927”, “DISPARLON 1958”, “DISPARLON P-410EF”, “DISPARLON P-420”, “DISPARLON P-425”, “DISPARLON PD-7”, “DISPARLON 1970”, “DISPARLON 230”, “DISPARLON LF-1980”, “DISPARLON LF-1982”, “DISPARLON LF-1983”, “DISPARLON LF-1084”, “DISPARLON LF-1985”, “DISPARLON LHP-90”, “DISPARLON LHP-91”, “DISPARLON LHP-95”, “DISPARLON LHP-96”, “DISPARLON OX-715”, “DISPARLON 1930N”, “DISPARLON 1931”, “DISPARLON 1933”, “DISPARLON 1934”, “DISPARLON 1711EF”, “DISPARLON 1751N”, “DISPARLON 1761”, “DISPARLON LS-009”, “DISPARLON LS-001”, and “DISPARLON LS-050” (manufactured by Kusumoto Chemicals, Ltd.), “PF-151N”, “PF-636”, “PF-6320”, “PF-656”, “PF-6520”, “PF-652-NF”, and “PF-3320” (manufactured by OMNOVA Solutions Inc), “POLYFLOW No. 7”, “POLYFLOW No. 50E”, “POLYFLOW No 50EHF”, “POLYFLOW No 54N”, “POLYFLOW No 77”, “POLYFLOW No 85HF”, “POLYFLOW No 90”, “POLYFLOW No 90D-50”, “POLYFLOW No 95”, “POLYFLOW No 99C”, “POLYFLOW KL-400K”, “POLYFLOW KL-400X”, “POLYFLOW KL-400HF”, “POLYFLOW KL-401”, “POLYFLOW KL-402”, “POLYFLOW KL403”, “POLYFLOW KL-404”, “POLYFLOW No 75”, “POLYFLOW No 85”, POLYFLOW KL-100”, “POLYFLOW LE-604”, “POLYFLOW KL-700”, “FLOWLEN AC-300”, “FLOWLEN AC-303”, “FLOWLEN AC-324”, “FLOWLEN AC-326F”, “FLOWLEN AC-530”, “FLOWLEN AC-903”, “FLOWLEN AC-903HF”, “FLOWLEN AC-1160”, “FLOWLEN AC-1190”, “FLOWLEN AC-2000”, “FLOWLEN AC-2300C”, “FLOWLEN AO-82”, “FLOWLEN AO-98”, and “FLOWLEN AO-108” (manufactured by KYOEISHA CHEMICAL Co., LTD.),
“FC-4430”, and “FC-4432” (manufactured by SUMITOMO 3M LIMITED), “L-7001”, “L-7002”, “8032 ADDITIVE”, “57 ADDITIVE”, “L-7064”, “FZ-2110”, “FZ-2105”, “67 ADDITIVE”, and “8616 ADDITIVE” (manufactured by Dow Corning Toray Co., Ltd.), and the like.

The amount of the surfactant added is preferably 0.01% to 2% by mass, and more preferably 0.05% to 0.5% by mass based on the polymerizable liquid crystal composition.

Further, in a case where the polymerizable liquid crystal composition of the present invention is an optical anisotropic body, the tilt angle of the air interface may be reduced efficiently by using the surfactant.

The polymerizable liquid crystal composition of the present invention has the effect of effectively reducing the tilt angle of the air interface in a case where the composition is an optical anisotropic body, and compounds having repetition units represented by the following Formula (7) and the weight average molecular weight of 100 or more may be used rather than the above surfactants.

[Chem. 41]

CR¹¹R¹²—CR¹³R¹⁴ (7)

In the formula, and R¹¹, R¹², R¹³ and R¹⁴ each independently represent a hydrogen atom, a halogen atom or a hydrocarbon group having 1 to 20 carbon atoms, and the hydrogen atom in the hydrocarbon group may be substituted by one or more halogen atoms.

Examples of the preferred compounds represented by Formula (7) include polyethylene, polypropylene, polyisobutylene, paraffin, liquid paraffin, chlorinated polypropylene, chlorinated paraffin, liquid chlorinated paraffin, and the like.

The compound represented by Formula (7) may be preferably added in the step of preparing a polymerizable solution by mixing the polymerizable compound with an organic solvent and heating and stirring the solution, but, after that step, may be added in the step of mixing the photopolymerization initiator in the polymerizable solution, or may be added in both steps.

The amount of the compound represented by Formula (7) added is preferably 0.01% to 1% by mass, and more preferably 0.05% to 0.5% by mass based on the polymerizable liquid crystal composition solution.

In a case where the polymerizable liquid crystal composition solution of the present invention is an optical anisotropic body, it is preferable to add a chain transfer agent to the composition in order to further improve the adhesiveness to a substrate. As the chain transfer agent, thiol compounds are preferable, monothiol, dithiol, trithiol, and tetrathiol compounds are more preferable, and trithiol compounds are even more preferable. Specifically, the compounds represented by the following Formulas (7-1) to (7-12) are preferable.

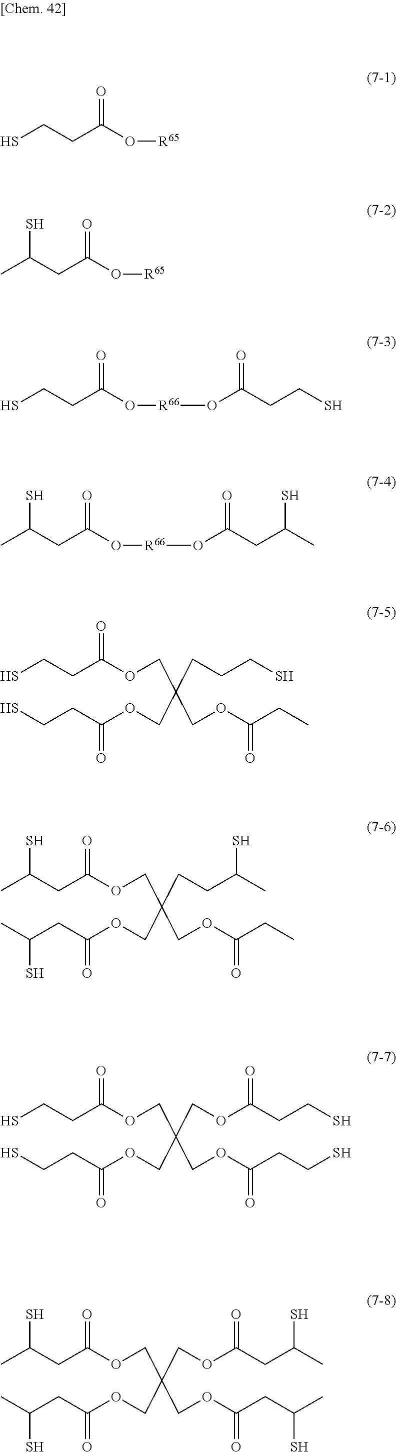

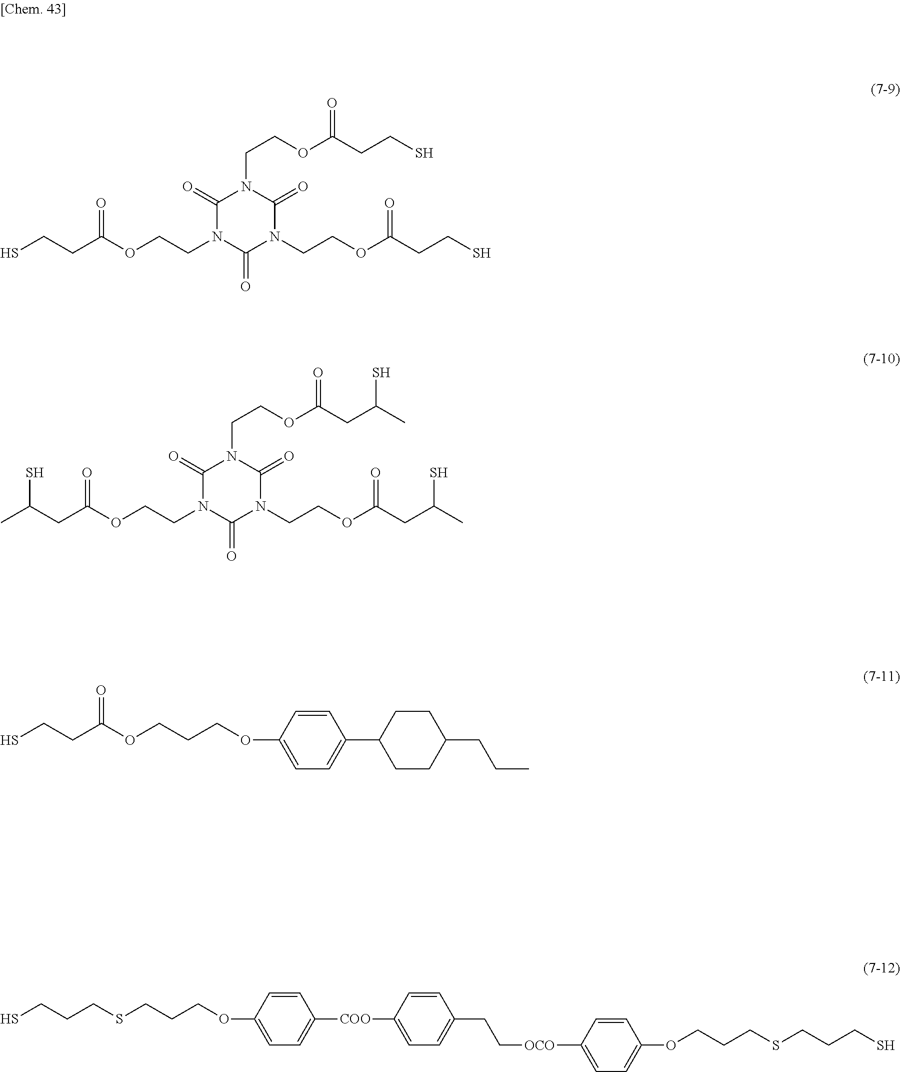

In the formulas, R⁶⁵ represents an alkyl group having 0 to 18 carbon atoms, the alkyl group may be a linear chain or a branched chain, one or more methylene groups in the alkyl group may be substituted with an oxygen atom, a sulfur atom, —CO—, —OCO—, —COO—, or —CH═CH— as long as an oxygen atom is not linked directly to another oxygen atom or a sulfur atom; and a sulfur atom is not linked directly to an oxygen atom or another sulfur atom, and R⁶⁶ represents an alkylene group having 2 to 18 carbon atoms, one or more methylene groups in the alkylene group may be substituted with an oxygen atom, a sulfur atom, —CO—, —OCO—, —COO—, or —CH═CH— as long as an oxygen atom is not linked directly to another oxygen atom or a sulfur atom; and a sulfur atom is not linked directly to an oxygen atom or another sulfur atom.

The chain transfer agent may be preferably added in the step of preparing a polymerizable solution by mixing the polymerizable liquid crystal compound with an organic solvent and heating and stirring the solution, but, after that step, may be added in the step of mixing the polymerization initiator in the polymerizable solution, or may be added in both steps.

The amount of the chain transfer agent added is preferably 0.5% to 10% by mass, and more preferably 1.0% to 5.0% by mass based on the polymerizable liquid crystal composition.

Liquid crystal compounds that are not polymerizable or polymerizable compounds that are not liquid crystalline may be added, if necessary, to further adjust physical properties. The polymerizable compounds that are not liquid crystalline may be preferably added in the step of preparing a polymerizable solution by mixing the polymerizable compound with an organic solvent and heating and stirring the solution, but liquid crystal compounds that are not polymerizable, after that step, may be added in the step of mixing the polymerization initiator in the polymerizable solution, or may be added in both steps. The amount of these compounds added is preferably 20% by mass or lower, more preferably 10% by mass or lower, and even more preferably 5% by mass or lower based on the polymerizable liquid crystal composition.

Other additives, for example, thioxo agents, ultraviolet absorbents, infrared absorbents, antioxidants, or surface treatment agents may be added to the extent of not significantly reducing the alignment capability of the liquid crystal according to the purpose in polymerizable mixture, or polymerizable composition of the present invention.

The total content of the mixture of the polymerizable composition is preferably 5.0% by mass or higher, preferably 10.0% by mass or higher, preferably 15.0% by mass or higher, further, preferably 90.0% by mass or lower, and preferably 85.0% by mass or lower based on the total amount of the polymerizable composition.

(Method of Manufacturing Mixture that Satisfies Formula (1))

In order to obtain a mixture satisfying Formula (1), for example, a method of adjusting the purification degree of the compound having a mesogenic group and finally obtaining a mixture that satisfies Formula 1 is exemplified. The purification degree of compounds having mesogenic groups may be adjusted by performing purification, if necessary, in the synthesis steps of compounds having mesogenic groups. The more the compound is purified, the smaller the value of yellowness index (YI) becomes. The purification may be carried out as appropriate in each step of the synthesis, and as a purification method, chromatography, recrystallization, distillation, sublimation, reprecipitation, adsorption, liquid separation processing, and the like are exemplified. In a case of using a purifying agent, as the purifying agent, silica gel, alumina, activated carbon, activated white clay, celite, zeolite, mesoporous silica, carbon nanotube, carbon nanohorn, Bincho charcoal, charcoal, graphene, ion-exchanged resins, acidic white clay, silicon dioxide, diatomaceous earth, perlite, cellulose, organic polymers, porous gel, and the like are exemplified.

(Production Method of Optical Anisotropic Body)

(Optical Anisotropic Body)

The optical anisotropic body produced by using the polymerizable composition of the present invention is a layer obtained by laminating a substrate, an alignment film, if necessary and a polymer of the polymerizable composition sequentially.

The substrates used for the optical anisotropic body of the present invention are substrates that are normally used in a liquid crystal device, a display, an optical component or an optical film, and are not particularly limited as long as the material thereof has heat resistance which is capable of withstanding heating during drying after applying the polymerizable composition of the present invention. Examples of such substrates include organic materials such as glass substrates, metal substrates, ceramics substrates or plastic substrates. Especially, in a case where the substrate is an organic material, cellulose derivatives, polyolefins, polyesters, polyolefins, polycarbonates, polyacrylates, polyarylates, polyether sulfones, polyimides, polyphenylene sulfides, polyphenylene ethers, nylon, polystyrenes, or the like are exemplified. Among them, plastic substrates such as polyesters, polystyrenes, polyolefins, cellulose derivatives, polyarylates, and polycarbonates are preferable.

The surface treatment of these substrates may be performed in order to improve applying properties and adhesiveness of the polymerizable composition of the present invention. As the surface treatment, ozone treatment, plasma treatment, corona treatment, silane coupling treatment, and the like are exemplified. Further, an organic thin film, an inorganic oxide thin film, a metal thin film, or the like is provided on the surface of a substrate by a method such as vapor deposition in order to adjust the transmittance and reflectance of light, or substrates may be pickup lens, rod lens, optical disks, a retardation film, a light diffusing film, a color filter, or the like in order to give the optical added value. Among them, pickup lens, a retardation film, a light diffusion film, and a color filter are preferable of which the higher added value becomes higher.

Further, the normal alignment treatment may be performed or the alignment film may be formed on the substrate so as to align the polymerizable composition when applying and drying the polymerizable composition of the present invention. As the alignment treatment, stretching treatment, rubbing treatment, polarization ultraviolet visible light irradiation treatment, and ion beam processing, and the like are exemplified. In a case of using an alignment film, the conventionally known alignment film may be used. Examples of such an alignment film include compounds such as polyimides, polysiloxanes, polyamides, polyvinyl alcohol, polycarbonates, polystyrenes, polyphenylene ethers, polyarylates, polyethylene terephthalates, polyether sulfones, epoxy resins, epoxy acrylate resins, acrylic resins, coumarin compounds, chalcone compounds, cinnamate compounds, fulgide compounds, anthraquinone compounds, azo compounds and arylethene compounds. For the compounds that are subjected to the alignment treatment by rubbing, the crystallization of the material may preferably be promoted by putting a heating step of the compounds during the alignment treatment or after the alignment treatment. It is preferable to use photoalignment materials for the compounds subjected to an alignment treatment other than rubbing.

(Applying)

As the method of obtaining an optical anisotropic body of the present invention, known conventional methods such as an applicator method, a bar coating method, a spin coating method, a roll coating method, a direct gravure coating method, a reverse gravure coating method, a flexo coating method, an inkjet method, a die coating method, a cap coating method, a dip coating method, a slit coating method, and the like may be performed. The polymerizable composition may be dried after applying.

(Polymerization Step)

The polymerization operation of the polymerizable liquid crystal composition of the present invention is generally carried out by irradiation with light such as ultraviolet rays or heating in a state where the liquid crystal compound of the polymerizable liquid crystal composition is horizontally aligned, vertically aligned, hybrid aligned, or cholesteric aligned (planar aligned) to the substrate. In a case where the polymerization is carried out by light irradiation, specifically to irradiate with an ultraviolet light having a wavelength of 390 nm or less is preferable and to irradiate with an ultraviolet light having a wavelength of 250 to 370 nm is most preferable. However, in a case where the polymerizable composition is decomposed by the ultraviolet light of 390 nm or less, it may be preferable to carry out polymerization treatment with ultraviolet light of 390 nm or more. It is preferable that this light is a diffused light and is an unpolarized light.

(Polymerization Method)

As a method of polymerizing a polymerizable liquid crystal composition of the present invention, a method of irradiating with an active energy ray, a thermal polymerization, or the like are exemplified, but the method of irradiating with the active energy ray is preferable since the reaction proceeds at room temperature without heating, and among them, the method of irradiating with light such as ultraviolet rays is preferable since the operation is simple. The temperature during irradiation is a temperature at which the polymerizable liquid crystal composition of the present invention may maintain liquid crystal phases and is preferably 30° C. or lower, if possible, in order to avoid the induction of the thermal polymerization of the polymerizable liquid crystal composition. In addition, during a temperature elevating step, the liquid crystal composition usually shows a liquid crystal phase within a range from an N-I transition temperature to C (solid phase)-N (nematic) transition temperature (hereinafter, abbreviated as C-N transition temperature.). On the other hand, the liquid crystal composition is in a thermodynamically non-equilibrium state, and thus the liquid crystal state may be maintained without solidification even at C-N transition temperature or less during a temperature lowering step. This state is referred to as a supercooled state. In the present invention, a liquid crystal composition that is in the supercooled state also maintains the liquid crystal phase. Specifically, to irradiate with the ultraviolet light having a wavelength of 390 nm or less is preferable, and to irradiate with light having a wavelength of 250 to 370 nm is most preferable. However, in a case where the polymerizable composition is decomposed with the ultraviolet light of 390 nm or less, it may be preferable to carry out polymerization treatment with ultraviolet light of 390 nm or more. It is preferable that this light is a diffused light and is an unpolarized light. The intensity of the ultraviolet ray irradiation is preferably in a range of 0.05 kW/m² to 10 kW/m². In particular, a range of 0.2 kW/m² to 2 kW/m² is preferable. In a case where the intensity of the ultraviolet ray is less than 0.05 kW/m², it takes a lot of time to complete the polymerization. On the other hand, if the intensity is greater than 2 kW/m², the liquid crystal molecules of the polymerizable liquid crystal composition tend to be photo-decomposed, and a lot of polymerization heat is generated, the temperature during polymerization increases, and the order parameter of the polymerizable liquid crystal changes, and thus there is a possibility that the deviation of the retardation of the film occurs after polymerization.

An optical anisotropic body having a plurality of regions having different alignment directions may be obtained by changing the alignment state of the unpolymerized part by applying the electric field, the magnetic field, the temperature, or the like and then polymerizing the unpolymerized part after only a specific part using mask is polymerized by the ultraviolet ray irradiation.

Further, an optical anisotropic body having a plurality of regions having different alignment directions may be obtained by regulating the alignment of the polymerizable liquid crystal composition of the unpolymerized state by previously applying the electric field, the magnetic field, the temperature, or the like to the composition and then polymerizing the unpolymerized part by irradiation with light from the mask while maintaining the state, when polymerizing only a specific part using mask by the ultraviolet ray irradiation.

The optical anisotropic body obtained by polymerizing the polymerizable liquid crystal composition of the present invention may be used alone as an optical anisotropic body which is peeled off from the substrate and may also be used as an optical anisotropic body as it is which is not peeled off from the substrate. In particular, since other members are hardly contaminated, it is useful in a case where the optical anisotropic body is used as a substrate to be layered or is used to be bonded to another substrate.

(Applications)

The polymer obtained by polymerizing the polymerizable liquid crystal composition of the application of the present invention in a state of being in a horizontal alignment, a vertical alignment, a hybrid alignment, or a cholesteric alignment, may be used as an optical compensation film, a retardation film, a film with expanded viewing angle, a film with enhanced luminance, a reflective film, a polarizing film, and an optical information recording material as an optical anisotropic body having alignment properties. Further, the polymer may be used as an adhesive having heat dissipation properties, a sealant, a heat dissipation sheet, and inks for security printing.

### EXAMPLES

Hereinafter, the present invention will be described by Synthesis Examples, Examples, and Comparative Examples, but the present invention is not limited thereto. Further, “parts” and “%” are based on mass, unless otherwise specified. As the raw compound of the compound having a mesogenic group, compounds represented by the following Formula (A2), Formula (A4), Formula (A5), Formulas (A8) to (A13), Formulas (B1) to (B12), and Formula (C3) were used.

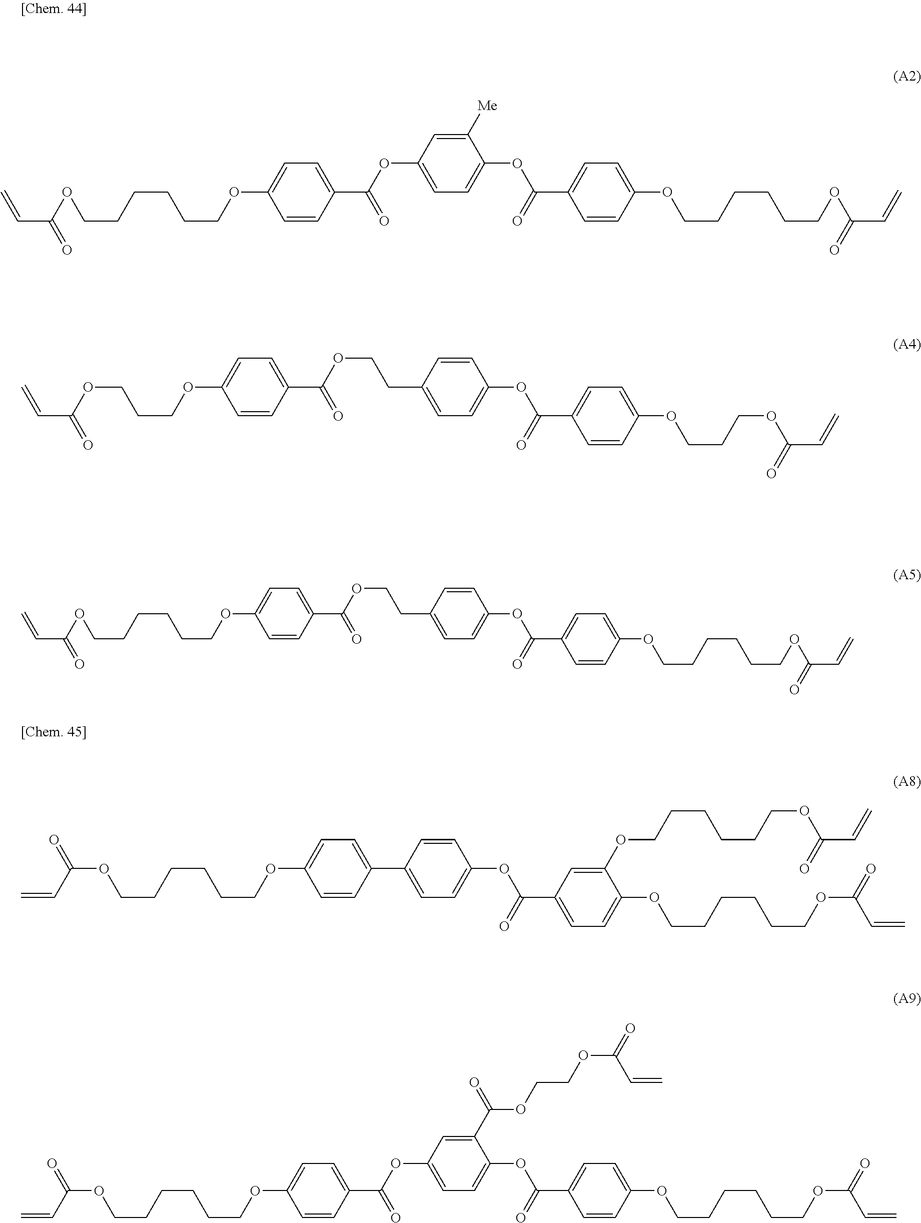

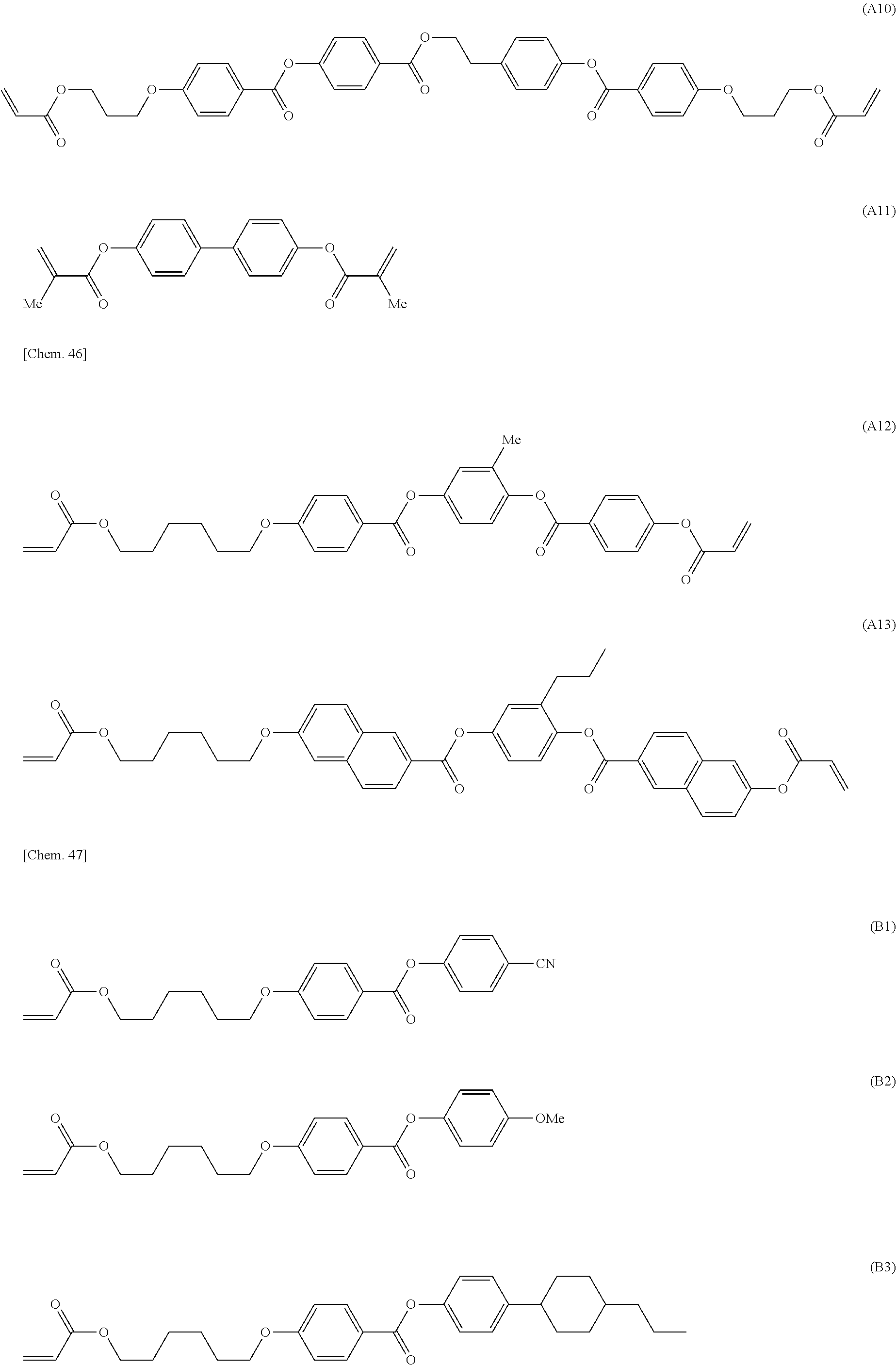

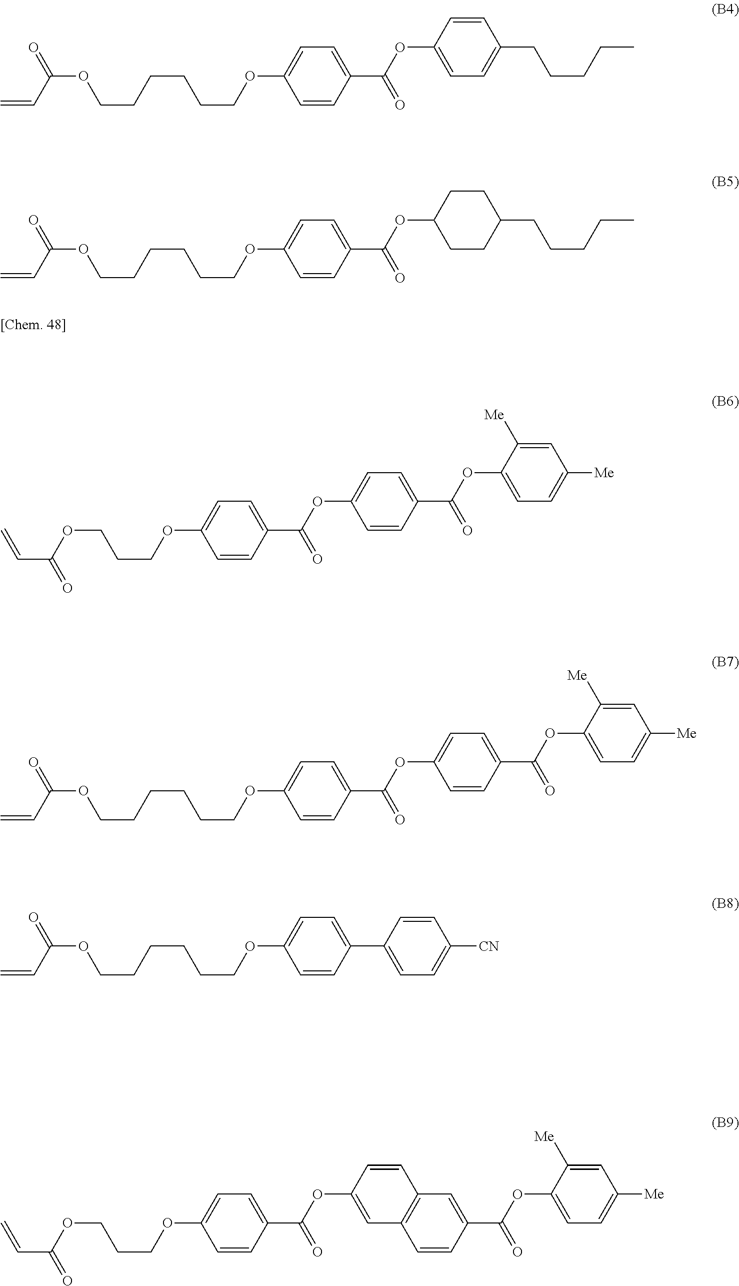

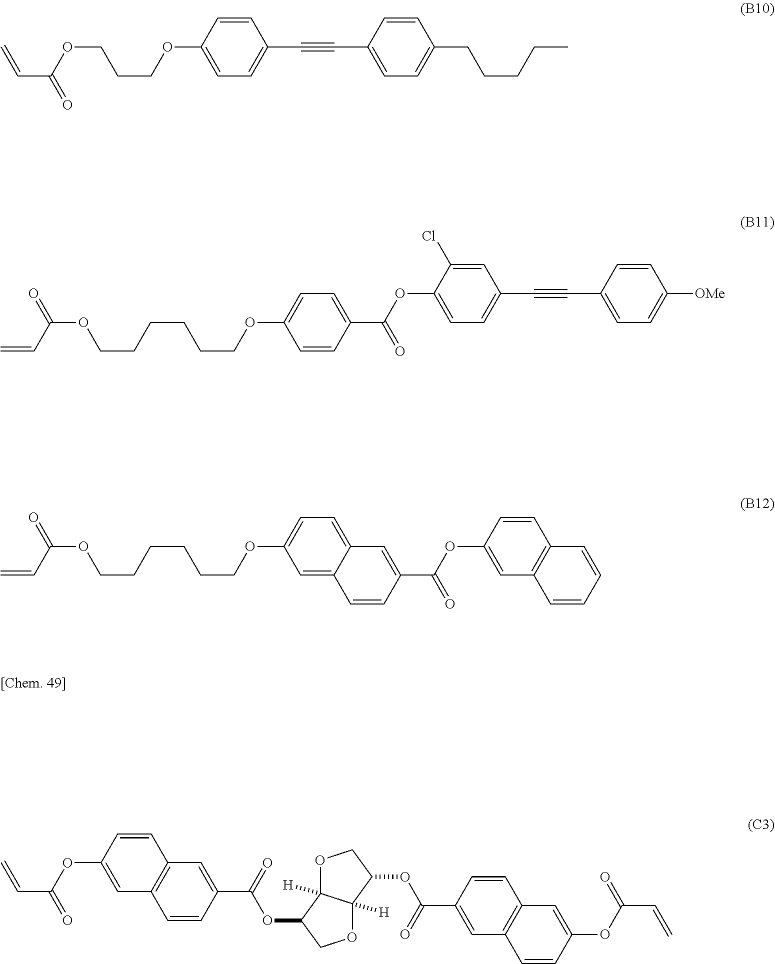

### <Measurement of YI/Δn>

The yellowness index of the mixture containing the compounds represented by Formula (A2), Formula (A4), Formula (A5), Formula (A8) to Formula (A13), and Formula (B1) to Formula (B12) was measured as follows.

A mixture which is a measurement object was dissolved in a solvent so as to be 20% of solution. Here, tetrahydrofuran solution was used as a solvent. The yellowness index was calculated using a spectrophotometer by putting the solution in a transparent cell having an optical path length of 1 cm.

In addition, the compound which is a measurement object is added to the host liquid crystal to prepare a liquid crystal composition. A glass cell is prepared by using glass substrates in which a polyimide alignment film is attached, and by combining the two glass substrates such that the substrates are parallel to the rubbing direction of the polyimide alignment film. The film is obtained by being peeled off from the glass cell after injecting the liquid crystal composition to the glass cell and curing the glass cell by irradiating with ultraviolet rays (illuminance of 800 mJ/cm²). Then, the refractive index anisotropy (Δn) is calculated by measuring the ne and no of the film using Abbe's refractometer and extrapolating the measured values.

The value of YI/Δn was calculated by dividing the yellowness index of the mixture represented by the obtained Formula (A2), Formula (A4), Formula (A5), Formulas (A8) to (A13), and Formulas (B1) to (B12) by the value of Δn of each compound.

The content of the compound in each mixture containing compounds represented by Formula (A11), Formula (B2), Formula (B3), Formula (B8), and Formula (B11) was calculated. ¹H NMR was measured by using a solution in which each mixture and the internal standard material were precisely mixed, and dissolved in a deuterated solvent. The content of the compound in each mixture was calculated from the relationship between the peak area derived from a compound in the obtained spectrum and the peak area derived from the inner standard substance. As an internal standard material, 1,4-BTMSB-d₄ standard substance or DSS-d₆ standard substance (TraceSure, manufactured by Wako Pure Chemical Industries, Ltd.) was used. The results are shown in Table 1.

TABLE 1

| Compound | Δn | YI | YI/Δn | Compound content |
|---|---|---|---|---|
| A11 | 0.130 | 6.60 | 50.8 | 78.5% |
| | | 6.20 | 47.7 | 81.1% |
| | | 5.00 | 38.5 | 95.5% |
| B2 | 0.110 | 5.70 | 51.8 | 76.5% |
| | | 4.00 | 36.4 | 90.6% |
| | | 0.60 | 5.5 | 95.4% |
| B3 | 0.140 | 6.50 | 46.4 | 81.5% |
| | | 2.50 | 17.9 | 95.6% |
| | | 0.20 | 1.4 | 98.3% |
| B8 | 0.199 | 8.00 | 40.2 | 82.1% |
| | | 0.40 | 2.0 | 95.2% |
| | | 0.25 | 1.3 | 98.1% |
| B11 | 0.264 | 14.20 | 53.8 | 79.2% |
| | | 5.50 | 20.8 | 91.2% |
| | | 0.45 | 1.7 | 99.9% |

### Examples 1-1 to 13-3 and Comparative Examples 1-1 to 13-2

As a mixture containing each compound represented by Formula (A2), Formula (A9), Formula (A11) to Formula (A13), Formula (B1) to Formula (B5), Formula (B8), Formula (B11), and Formula (B12), a mixture having different degree of purification was prepared. Each compound was prepared by known synthesis methods and methods equivalent thereto. The following purification methods were performed once or multiple times on the obtained crude material, and further mixtures which have different values of YI were obtained by appropriately adjusting the amount of the purifying agent and solvents used.

(Purification Method 1)

The crude material was dissolved in dichloromethane, activated carbon was added thereto, and the solution was heated and stirred. The activated carbon was removed by filtration, and the solvent was distilled off. Column chromatography (silica gel and alumina) and recrystallization were performed to obtain a mixture.

(Purification Method 2)

The crude material was dissolved in dichloromethane and hexane, and the purification was performed by column chromatography (silica gel and alumina) to obtain a mixture.

(Purification Method 3)

The crude material was dissolved in dichloromethane and acetone, activated carbon was added thereto, and the solution was heated and stirred. The activated carbon was removed by filtration and the solvent was distilled off to obtain a mixture.

(Purification Method 4)

The crude material was dissolved in toluene, silica gel and alumina were added thereto, and the solution was stirred at room temperature for an hour. The silica gel and alumina were removed by filtration and the solvent was distilled off to obtain a mixture.

(Purification Method 5)

The crude material was dispersed in methanol and stirred at room temperature for an hour. The obtained material was filtrated and dried to obtain a mixture.

Further, yield was obtained in purification step from crude material for each mixture obtained by performing purification. YI/Δn of each mixture was measured. The results are shown in Table 2 and Table 3.

TABLE 2

| | Com- | | | | Purification | |
|---|---|---|---|---|---|---|
| | pound | Δn | YI | YI/Δn | method | Yield |
| Comparative | A2 | 0.160 | 0.10 | 0.6 | 1 | 25% |
| Example 1-1 | | | | | | |
| Example 1-1 | | | 0.16 | 1.0 | 2 | 65% |
| Example 1-2 | | | 6.20 | 38.8 | 3 | 86% |
| Example 1-3 | | | 8.00 | 50.0 | 4 | 88% |
| Comparative | | | 8.10 | 50.6 | 4 | 82% |
| Example 1-2 | | | | | | |
| Comparative | A9 | 0.120 | 0.10 | 0.8 | 1 | 22% |
| Example 2-1 | | | | | | |
| Example 2-1 | | | 0.12 | 1.0 | 2 | 45% |
| Example 2-2 | | | 0.60 | 5.0 | 2 | 56% |
| Example 2-3 | | | 6.00 | 50.0 | 3 | 89% |
| Comparative | | | 6.50 | 54.2 | 3 | 80% |
| Example 2-2 | | | | | | |
| Comparative | A11 | 0.130 | 0.10 | 0.8 | 1 | 27% |
| Example 3-1 | | | | | | |
| Example 3-1 | | | 0.15 | 1.2 | 2 | 66% |
| Example 3-2 | | | 1.70 | 13.1 | 2 | 70% |
| Example 3-3 | | | 6.40 | 49.2 | 4 | 89% |
| Comparative | | | 8.20 | 63.1 | 5 | 81% |
| Example 3-2 | | | | | | |
| Comparative | A12 | 0.160 | 0.12 | 0.8 | 1 | 34% |
| Example 4-1 | | | | | | |
| Example 4-1 | | | 0.22 | 1.4 | 2 | 72% |
| Example 4-2 | | | 2.00 | 12.5 | 2 | 87% |
| Example 4-3 | | | 7.90 | 49.4 | 4 | 95% |
| Comparative | | | 9.60 | 60.0 | 4 | 92% |
| Example 4-2 | | | | | | |
| Comparative | A13 | 0.260 | 0.12 | 0.5 | 1 | 12% |
| Example 5-1 | | | | | | |
| Example 5-1 | | | 0.30 | 1.2 | 2 | 55% |
| Example 5-2 | | | 2.00 | 7.7 | 2 | 75% |
| Example 5-3 | | | 13.00 | 50.0 | 4 | 77% |
| Comparative | | | 14.20 | 54.6 | 5 | 74% |
| Example 5-2 | | | | | | |
| Comparative | B1 | 0.130 | 0.10 | 0.8 | 1 | 45% |
| Example 6-1 | | | | | | |
| Example 6-1 | | | 0.20 | 1.5 | 2 | 72% |
| Example 6-2 | | | 0.70 | 5.4 | 2 | 76% |
| Example 6-3 | | | 6.40 | 49.2 | 3 | 92% |
| Comparative | | | 7.70 | 59.2 | 3 | 87% |
| Example 6-2 | | | | | | |
| Comparative | B2 | 0.110 | 0.10 | 0.9 | 1 | 32% |
| Example 7-1 | | | | | | |
| Example 7-1 | | | 0.12 | 1.1 | 1 | 65% |
| Example 7-2 | | | 4.40 | 40.0 | 4 | 91% |
| Example 7-3 | | | 5.40 | 49.1 | 4 | 89% |
| Comparative | | | 6.60 | 60.0 | 5 | 80% |
| Example 7-2 | | | | | | |

TABLE 3

| | Com- | | | | Purification | |
|---|---|---|---|---|---|---|
| | pound | Δn | YI | YI/Δn | method | Yield |
| Comparative | B3 | 0.140 | 0.11 | 0.8 | 1 | 27% |
| Example 8-1 | | | | | | |
| Example 8-1 | | | 0.20 | 1.4 | 2 | 59% |
| Example 8-2 | | | 5.50 | 39.3 | 4 | 92% |
| Example 8-3 | | | 6.80 | 48.6 | 4 | 89% |
| Comparative | | | 8.50 | 60.7 | 5 | 85% |
| Example 8-2 | | | | | | |
| Comparative | B4 | 0.120 | 0.10 | 0.8 | 1 | 35% |
| Example 9-1 | | | | | | |
| Example 9-1 | | | 0.15 | 1.3 | 1 | 72% |
| Example 9-2 | | | 4.00 | 33.3 | 4 | 87% |
| Example 9-3 | | | 5.80 | 48.3 | 4 | 95% |
| Comparative | | | 7.20 | 60.0 | 5 | 82% |
| Example 9-2 | | | | | | |
| Comparative | B5 | 0.110 | 0.10 | 0.9 | 1 | 66% |
| Example 10-1 | | | | | | |
| Example 10-1 | | | 0.15 | 1.4 | 1 | 85% |
| Example 10-2 | | | 2.00 | 18.2 | 2 | 92% |
| Example 10-3 | | | 5.30 | 48.2 | 4 | 96% |
| Comparative | | | 7.40 | 67.3 | 4 | 89% |
| Example 10-2 | | | | | | |
| Comparative | B8 | 0.199 | 0.14 | 0.7 | 2 | 27% |
| Example 11-1 | | | | | | |
| Example 11-1 | | | 0.20 | 1.0 | 2 | 65% |
| Example 11-2 | | | 4.50 | 22.6 | 3 | 87% |
| Example 11-3 | | | 9.90 | 49.7 | 4 | 95% |
| Comparative | | | 11.20 | 56.3 | 4 | 91% |
| Example 11-2 | | | | | | |
| Comparative | B11 | 0.264 | 0.10 | 0.4 | 1 | 12% |
| Example 12-1 | | | | | | |
| Example 12-1 | | | 0.30 | 1.1 | 2 | 55% |
| Example 12-2 | | | 6.50 | 24.6 | 3 | 75% |
| Example 12-3 | | | 13.00 | 49.2 | 3 | 77% |
| Comparative | | | 15.10 | 57.2 | 5 | 72% |
| Example 12-2 | | | | | | |
| Comparative | B12 | 0.220 | 0.20 | 0.9 | 2 | 40% |
| Example 13-1 | | | | | | |
| Example 13-1 | | | 0.30 | 1.4 | 2 | 65% |
| Example 13-2 | | | 2.00 | 9.1 | 4 | 75% |
| Example 13-3 | | | 11.00 | 50.0 | 4 | 77% |
| Comparative | | | 13.30 | 60.5 | 4 | 72% |
| Example 13-2 | | | | | | |

As seen from Table 2, if the value of YI/Δn of Comparative Example (1-1), Comparative Example (2-1), Comparative Example (3-1), and the like is less than 1, the yield is low. On the other hand, if the value of YI/Δn is 1 or greater, the yield becomes larger as the value of YI/Δn becomes greater, but if the value of YI/Δn of Comparative Example (1-2), Comparative Example (2-2), Comparative Example (3-2), and the like is greater than 50, the yield is reduced. Among each compound represented by Formula (A2), Formula (A9), Formulas (A11) to (A13), Formulas (B1) to (B5), Formula (B8), Formula (B11), and Formula (B12), in a mixture containing a compound which has relatively large Δn such as compounds represented by Formula (A13) and Formula (B11), there is a tendency that the yield becomes lower as the value of YI becomes larger. However, in any of the above mixtures, a mixture having a value of YI/Δn falling within a range of 1.0 to 50 was possible to suppress a deterioration of yield.

### Examples 14-1 to 18-3 and Comparative Examples 14-1 to 18-2

The host liquid crystal (1) was prepared using the compounds shown in Table 4 below. The yellowness index of the host liquid crystal (1) was 0.32, and YI/Δn was 1.7. Further, the yellowness index of the host liquid crystal (1) was measured by dissolving the host liquid crystal (1) in tetrahydrofuran solution so as to be 20% of solution in the same manner as in the measurement method of the above compounds. The YI/Δn of the host liquid crystal (1) was calculated by dividing the value obtained after measuring by the refractive index anisotropy (Δn) of the host liquid crystal (1).

TABLE 4

Host liquid crystal (1)

| Compound | Composition | YI | Δn | YI/Δn |
|---|---|---|---|---|
| A4 | 30.0% | 0.20 | 0.175 | 1.1 |
| A5 | 10.0% | 0.20 | 0.160 | 1.3 |
| A10 | 30.0% | 0.20 | 0.200 | 1.0 |
| B6 | 30.0% | 0.60 | 0.184 | 3.3 |
| Host liquid | 100.0% | 0.32 | 0.18 | 1.7 |
| crystal | | | | |

Each of 30.0% of a mixture containing a compound represented by Formula (A2), 50.0% of a mixture containing a compound represented by Formula (A9), 30.0% of a mixture containing a compound represented by Formula (B1), 40.0% of a mixture containing a compound represented by Formula (B2), and 15.0% of a mixture containing a compound represented by Formula (B8) was added to the host liquid crystal (1) to obtain liquid crystal compositions of Examples 14-1 to 18-3 and Comparative Examples 14-1 to 18-2. The yellowness index (YI), refractive index anisotropy (Δn), and YI/Δn of the liquid crystal compositions of Examples 14-1 to 18-3 and Comparative Examples 14-1 to 18-2 were obtained. Further, the yellowness index of these liquid crystal compositions was obtained in the same manner as for the above host liquid crystal (1).

<Evaluation of Repellence Degree at Time of Film Production>

5.0 parts by mass of the photopolymerization initiator IRGACURE 907(manufactured by BASF SE) and 0.1 parts by mass of the p-methoxyphenol were added to each of the liquid crystal compositions of Examples 14-1 to 18-3 and Comparative Examples 14-1 to 18-2, and stored at 40° C. for a month.

The solution after storage was applied on TAC (triacetyl cellulose) film with a bar coater #4 at room temperature and then dried at 80° C. for 2 minutes. Then, after standing at room temperature for 2 minutes, the resultant was irradiated with UV light with the illuminance of 500 mJ/cm².

Evaluation Method of Repellence Degree

A: repellence was not observed at all

B: repellence was slightly observed

C: repellence was slightly a lot observed

D: repellence was excessively observed

<Evaluation of Alignment Properties of Film>

The polyimide solution for the alignment film was applied on the glass substrate having a thickness of 0.7 mm with a spin coating method at room temperature, dried at 100° C. for 10 minutes, and then baked at 200° C. for 60 minutes to obtain a coating film. The obtained coating film was subjected to rubbing treatment to obtain a substrate. 5.0 parts by mass of the photopolymerization initiator IRGACURE 907 (manufactured by BASF SE) and 0.1 parts by mass of the p-methoxyphenol were added to each of the liquid crystal compositions of Examples 14-1 to 18-3 and Comparative Examples 14-1 to 18-2, and the solution was stored at 60° C. for a month. The solution was applied on the substrate with a spin coater and then dried at 80° C. for 2 minutes. Then, after standing at room temperature for 2 minutes, the resultant was irradiated with UV light with the illuminance of 500 mJ/cm².

A: No defect was detected by visual inspection, and no defect was detected also by the polarizing microscope observation.

B: No defect was detected by visual inspection, but the non-aligned portion was detected in a part by the polarizing microscope observation.

C: Some defect was detected by visual inspection, and the non-aligned portion was detected in a part by the polarizing microscope observation.

D: Some defect was detected by visual inspection, and non-aligned portion was also entirely detected by the polarizing microscope observation. The results are shown in Table 5.

TABLE 5

| | | | | Amount | | Alignment |
|---|---|---|---|---|---|---|
| | Compound | | YI/Δn | added | Repellence | properties |
| Host liquid | Blank | | 1.7 | — | A | A |
| crystal (1) | | | | | | |
| Comparative | A2 | Comparative | 0.6 | 30.0% | C | C |
| Example 14-1 | | Example 1-1 | | | | |
| Example 14-1 | | Example 1-1 | 1.0 | 30.0% | B | B |
| Example 14-2 | | Example 1-2 | 38.8 | 30.0% | A | A |
| Example 14-3 | | Example 1-3 | 50.0 | 30.0% | B | B |
| Comparative | | Comparative | 50.6 | 30.0% | D | D |
| Example 14-2 | | Example 1-2 | | | | |
| Comparative | A9 | Comparative | 0.8 | 50.0% | C | D |
| Example 15-1 | | Example 2-1 | | | | |
| Example 15-1 | | Example 2-1 | 1.0 | 50.0% | B | B |
| Example 15-2 | | Example 2-2 | 3.3 | 50.0% | A | A |
| Example 15-3 | | Example 2-3 | 50.0 | 50.0% | B | B |
| Comparative | | Comparative | 54.2 | 50.0% | C | D |
| Example 15-2 | | Example 2-2 | | | | |
| Comparative | B1 | Comparative | 0.8 | 30.0% | C | C |
| Example 16-1 | | Example 6-1 | | | | |
| Example 16-1 | | Example 6-1 | 1.5 | 30.0% | B | B |
| Example 16-2 | | Example 6-2 | 3.1 | 30.0% | A | A |
| Example 16-3 | | Example 6-3 | 49.2 | 30.0% | B | B |
| Comparative | | Comparative | 59.2 | 30.0% | D | D |
| Example 16-2 | | Example 6-2 | | | | |
| Comparative | B2 | Comparative | 0.9 | 40.0% | C | D |
| Example 17-1 | | Example 7-1 | | | | |
| Example 17-1 | | Example 7-1 | 1.1 | 40.0% | B | B |
| Example 17-2 | | Example 7-2 | 40.0 | 40.0% | A | A |
| Example 17-3 | | Example 7-3 | 49.1 | 40.0% | B | C |
| Comparative | | Comparative | 60.0 | 40.0% | D | D |
| Example 17-2 | | Example 7-2 | | | | |
| Comparative | B8 | Comparative | 0.7 | 15.0% | D | D |
| Example 18-1 | | Example 11-1 | | | | |
| Example 18-1 | | Example 11-1 | 1.0 | 15.0% | B | B |
| Example 18-2 | | Example 11-2 | 22.6 | 15.0% | A | A |
| Example 18-3 | | Example 11-3 | 49.7 | 15.0% | C | B |
| Comparative | | Comparative | 56.3 | 15.0% | D | D |
| Example 18-2 | | Example 11-2 | | | | |

### Examples 19-1 to 23-3 and Comparative Examples 19-1 to 23-2

The host liquid crystal (2) was adjusted using the compounds shown in Table 6 below. The yellowness index of the host liquid crystal (2) was 0.33, and YI/Δn was 1.8. Further, the yellowness index of the host liquid crystal (2) was measured in the same manner as for the above host liquid crystal (1).

TABLE 6

Host liquid crystal (2)

| Compound | Composition | YI | Δn | YI/Δn |
|---|---|---|---|---|
| A5 | 30.0% | 0.20 | 0.160 | 1.3 |
| A10 | 30.0% | 0.20 | 0.200 | 1.0 |
| B6 | 10.0% | 0.60 | 0.184 | 3.3 |
| B7 | 30.0% | 0.50 | 0.185 | 2.7 |
| Host liquid | 100.0% | 0.33 | 0.18 | 1.8 |
| crystal | | | | |
| composition | | | | |

Each of 5.0% of a mixture containing a compound represented by Formula (A11), 10.0% of a mixture containing a compound represented by Formula (A12), 20.0% of a mixture containing a compound represented by Formula (A13), 60.0% of a mixture containing a compound represented by Formula (B3), and 30.0% of a mixture containing a compound represented by Formula (B4) was added to the host liquid crystal (2) to obtain liquid crystal compositions of Examples 19-1 to 23-3 and Comparative Examples 19-1 to 23-2. Each of the yellowness index (YI), refractive index anisotropy (Δn), and YI/Δn of the liquid crystal compositions of Examples 19-1 to 23-3 and Comparative Examples 19-1 to 23-2 was obtained. Further, the yellowness index of these liquid crystal compositions was obtained in the same manner as for the above host liquid crystal (1).

The evaluation of repellence degree at the time of film production and evaluation of alignment properties of the film were carried out on the liquid crystal compositions of Examples 19-1 to 23-3 and Comparative Examples 19-1 to 23-2 in the same manner as for the liquid crystal composition of the above Examples 14-1 to 18-3 and Comparative Examples 14-1 to 18-2. The results are shown in Table 7.

TABLE 7

| | | | | Amount | | Alignment |
|---|---|---|---|---|---|---|
| | Compound | | YI/Δn | added | Repellence | properties |
| Host liquid | Blank | | 1.8 | — | A | A |
| crystal (2) | | | | | | |
| Comparative | A11 | Comparative | 0.8 | 5.0% | C | D |
| Example 19-1 | | Example 3-1 | | | | |
| Example 19-1 | | Example 3-1 | 1.2 | 5.0% | B | B |
| Example 19-2 | | Example 3-2 | 13.1 | 5.0% | A | A |
| Example 19-3 | | Example 3-3 | 49.2 | 5.0% | B | C |
| Comparative | | Comparative | 63.1 | 5.0% | D | D |
| Example 19-2 | | Example 3-2 | | | | |
| Comparative | A12 | Comparative | 0.8 | 10.0% | C | C |
| Example 20-1 | | Example 4-1 | | | | |
| Example 20-1 | | Example 4-1 | 1.4 | 10.0% | B | B |
| Example 20-2 | | Example 4-2 | 12.5 | 10.0% | A | A |
| Example 20-3 | | Example 4-3 | 49.4 | 10.0% | B | C |
| Comparative | | Comparative | 60.0 | 10.0% | D | D |
| Example 20-2 | | Example 4-2 | | | | |
| Comparative | A13 | Comparative | 0.5 | 20.0% | D | D |
| Example 21-1 | | Example 5-1 | | | | |
| Example 21-1 | | Example 5-1 | 1.2 | 20.0% | B | B |
| Example 21-2 | | Example 5-2 | 7.7 | 20.0% | A | A |
| Example 21-3 | | Example 5-3 | 50.0 | 20.0% | C | B |
| Comparative | | Comparative | 54.6 | 20.0% | D | D |
| Example 21-2 | | Example 5-2 | | | | |
| Comparative | B3 | Comparative | 0.8 | 60.0% | C | C |
| Example 22-1 | | Example 8-1 | | | | |
| Example 22-1 | | Example 8-1 | 1.4 | 60.0% | B | B |
| Example 22-2 | | Example 8-2 | 39.3 | 60.0% | A | A |
| Example 22-3 | | Example 8-3 | 48.6 | 60.0% | B | C |
| Comparative | | Comparative | 60.7 | 60.0% | D | D |
| Example 22-2 | | Example 8-2 | | | | |
| Comparative | B4 | Comparative | 0.8 | 30.0% | D | D |
| Example 23-1 | | Example 9-1 | | | | |
| Example 23-1 | | Example 9-1 | 1.3 | 30.0% | B | B |
| Example 23-2 | | Example 9-2 | 33.3 | 30.0% | A | A |
| Example 23-3 | | Example 9-3 | 48.3 | 30.0% | C | B |
| Comparative | | Comparative | 60.0 | 30.0% | D | D |
| Example 23-2 | | Example 9-2 | | | | |

### Examples 24-1 to 28-3 and Comparative Examples 24-1 to 28-2

The host liquid crystal (3) was adjusted using the compounds shown in Table 8 below. The yellowness index of the host liquid crystal (3) was 0.47, and YI/Δn was 2.5. Further, the yellowness index of the host liquid crystal (3) was measured in the same manner as for the above host liquid crystal (1).

TABLE 8

Host liquid crystal (3)

| Compound | Composition | YI | Δn | YI/Δn |
|---|---|---|---|---|
| A4 | 20.0% | 0.20 | 0.175 | 1.1 |
| A5 | 20.0% | 0.20 | 0.160 | 1.3 |
| A10 | 20.0% | 0.20 | 0.200 | 1.0 |
| B7 | 30.0% | 0.50 | 0.185 | 2.7 |
| B12 | 10.0% | 2.00 | 0.220 | 9.1 |
| Host liquid | 100.0% | 0.47 | 0.19 | 2.5 |
| crystal | | | | |
| composition | | | | |

Each of 30.0% of a mixture containing a compound represented by Formula (A9), 10.0% of a mixture containing a compound represented by Formula (A11), 50.0% of a mixture containing a compound represented by Formula (B1), 10.0% of a mixture containing a compound represented by Formula (B4), and 55.0% of a mixture containing a compound represented by Formula (B5) was added to the host liquid crystal (3) to obtain liquid crystal compositions of Examples 24-1 to 28-3 and Comparative Examples 24-1 to 28-2. Each of the yellowness index (YI), refractive index anisotropy (Δn), and YI/Δn of the liquid crystal compositions of Examples 24-1 to 28-3 and Comparative Examples 24-1 to 28-2 was obtained. Further, the yellowness index of these liquid crystal compositions was obtained in the same manner as for the above host liquid crystal (1).

The evaluation of repellence degree at the time of film production and evaluation of alignment properties of the film were carried out on the liquid crystal compositions of Examples 24-1 to 28-3 and Comparative Examples 24-1 to 28-2 in the same manner as for the liquid crystal composition of the above Examples 14-1 to 18-3 and Comparative Examples 14-1 to 18-2. The results are shown in Table 9.

TABLE 9

| | | | | Amount | | Alignment |
|---|---|---|---|---|---|---|
| | Compound | | YI/Δn | added | Repellence | properties |
| Host liquid | Blank | | 2.5 | — | A | A |
| crystal (3) | | | | | | |
| Comparative | A9 | Comparative | 0.8 | 30.0% | C | D |
| Example 24-1 | | Example 2-1 | | | | |
| Example 24-1 | | Example 2-1 | 1.0 | 30.0% | B | B |
| Example 24-2 | | Example 2-2 | 3.3 | 30.0% | A | A |
| Example 24-3 | | Example 2-3 | 50.0 | 30.0% | B | B |
| Comparative | | Comparative | 54.2 | 30.0% | C | D |
| Example 24-2 | | Example 2-2 | | | | |
| Comparative | A11 | Comparative | 0.8 | 10.0% | C | D |
| Example 25-1 | | Example 3-1 | | | | |
| Example 25-1 | | Example 3-1 | 1.2 | 10.0% | B | B |
| Example 25-2 | | Example 3-2 | 13.1 | 10.0% | A | A |
| Example 25-3 | | Example 3-3 | 49.2 | 10.0% | B | C |
| Comparative | | Comparative | 63.1 | 10.0% | D | D |
| Example 25-2 | | Example 3-2 | | | | |
| Comparative | B1 | Comparative | 0.8 | 50.0% | C | C |
| Example 26-1 | | Example 6-1 | | | | |
| Example 26-1 | | Example 6-1 | 1.5 | 50.0% | B | B |
| Example 26-2 | | Example 6-2 | 3.1 | 50.0% | A | A |
| Example 26-3 | | Example 6-3 | 49.2 | 50.0% | B | B |
| Comparative | | Comparative | 59.2 | 50.0% | D | D |
| Example 26-2 | | Example 6-2 | | | | |
| Comparative | B4 | Comparative | 0.8 | 10.0% | D | D |
| Example 27-1 | | Example 9-1 | | | | |
| Example 27-1 | | Example 9-1 | 1.3 | 10.0% | B | B |
| Example 27-2 | | Example 9-2 | 33.3 | 10.0% | A | A |
| Example 27-3 | | Example 9-3 | 48.3 | 10.0% | C | B |
| Comparative | | Comparative | 60.0 | 10.0% | D | D |
| Example 27-2 | | Example 9-2 | | | | |
| Comparative | B5 | Comparative | 0.9 | 55.0% | C | C |
| Example 28-1 | | Example 10-1 | | | | |
| Example 28-1 | | Example 10-1 | 1.4 | 55.0% | B | B |
| Example 28-2 | | Example 10-2 | 18.2 | 55.0% | A | A |
| Example 28-3 | | Example 10-3 | 48.2 | 55.0% | B | C |
| Comparative | | Comparative | 67.3 | 55.0% | D | D |
| Example 28-2 | | Example 10-2 | | | | |

### Examples 29-1 to 33-3 and Comparative Examples 29-1 to 33-2

The host liquid crystal (4) was adjusted using the compounds shown in Table 10 below. The yellowness index of the host liquid crystal (4) was 0.55, and YI/Δn was 2.9. Further, the yellowness index of the host liquid crystal (4) was measured in the same manner as for the above host liquid crystal (1).

TABLE 10

Host liquid crystal (4)

| Compound | Composition | YI | Δn | YI/Δn |
|---|---|---|---|---|
| A4 | 30.0% | 0.20 | 0.175 | 1.1 |
| A10 | 25.0% | 0.20 | 0.200 | 1.0 |
| B9 | 40.0% | 1.10 | 0.225 | 4.9 |
| C3 | 5.0% | | | |
| Host liquid | 100.0% | 0.55 | 0.193 | 2.9 |
| crystal | | | | |
| composition | | | | |

Each of 70.0% of a mixture containing a compound represented by Formula (A2), 50.0% of a mixture containing a compound represented by Formula (A12), 90.0% of a mixture containing a compound represented by Formula (A13), 5.0% of a mixture containing a compound represented by Formula (B11), and 25.0% of a mixture containing a compound represented by Formula (B12) was added to the host liquid crystal (4) to obtain liquid crystal compositions of Examples 29-1 to 33-3 and Comparative Examples 29-1 to 33-2. Each of the yellowness index (YI), refractive index anisotropy (Δn), and YI/Δn of the liquid crystal compositions of Examples 29-1 to 33-3 and Comparative Examples 29-1 to 33-2 was obtained. Further, the yellowness index of these liquid crystal compositions was obtained in the same manner as for the above host liquid crystal (1).

The evaluation of repellence degree at the time of film production and evaluation of alignment properties of the film were carried out on the liquid crystal compositions of Examples 29-1 to 33-3 and Comparative Examples 29-1 to 33-2 in the same manner as for the liquid crystal composition of the above Examples 14-1 to 18-3 and Comparative Examples 14-1 to 18-2. The results are shown in Table 11.

TABLE 11

| | | | | Amount | | Alignment |
|---|---|---|---|---|---|---|
| | Compound | | YI/Δn | added | Repellence | properties |
| Host liquid | Blank | | 2.9 | — | A | A |
| crystal (4) | | | | | | |
| Comparative | A2 | Comparative | 0.6 | 70.0% | C | C |
| Example 29-1 | | Example 1-1 | | | | |
| Example 29-1 | | Example 1-1 | 1.0 | 70.0% | B | B |
| Example 29-2 | | Example 1-2 | 38.8 | 70.0% | A | A |
| Example 29-3 | | Example 1-3 | 50.0 | 70.0% | B | B |
| Comparative | | Comparative | 50.6 | 70.0% | D | D |
| Example 29-2 | | Example 1-2 | | | | |
| Comparative | A12 | Comparative | 0.8 | 50.0% | C | C |
| Example 30-1 | | Example 4-1 | | | | |
| Example 30-1 | | Example 4-1 | 1.4 | 50.0% | B | B |
| Example 30-2 | | Example 4-2 | 12.5 | 50.0% | A | A |
| Example 30-3 | | Example 4-3 | 49.4 | 50.0% | B | C |
| Comparative | | Comparative | 60.0 | 50.0% | D | D |
| Example 30-2 | | Example 4-2 | | | | |
| Comparative | A13 | Comparative | 0.5 | 90.0% | D | D |
| Example 31-1 | | Example 5-1 | | | | |
| Example 31-1 | | Example 5-1 | 1.2 | 90.0% | B | B |
| Example 31-2 | | Example 5-2 | 7.7 | 90.0% | A | A |
| Example 31-3 | | Example 5-3 | 50.0 | 90.0% | C | B |
| Comparative | | Comparative | 54.6 | 90.0% | D | D |
| Example 31-2 | | Example 5-2 | | | | |
| Comparative | B11 | Comparative | 0.4 | 5.0% | C | C |
| Example 32-1 | | Example 12-1 | | | | |
| Example 32-1 | | Example 12-1 | 1.1 | 5.0% | B | B |
| Example 32-2 | | Example 12-2 | 24.6 | 5.0% | A | A |
| Example 32-3 | | Example 12-3 | 49.2 | 5.0% | B | B |
| Comparative | | Comparative | 57.2 | 5.0% | D | D |
| Example 32-2 | | Example 12-2 | | | | |
| Comparative | B12 | Comparative | 0.9 | 25.0% | C | D |
| Example 33-1 | | Example 13-1 | | | | |
| Example 33-1 | | Example 13-1 | 1.4 | 25.0% | B | B |
| Example 33-2 | | Example 13-2 | 9.1 | 25.0% | A | A |
| Example 33-3 | | Example 13-3 | 50.0 | 25.0% | B | C |
| Comparative | | Comparative | 60.5 | 25.0% | D | D |
| Example 33-2 | | Example 13-2 | | | | |

### Examples 34-1 to 38-3 and Comparative Examples 34-1 to 38-2

The host liquid crystal (5) was adjusted using the compounds shown in Table 12 below. The yellowness index of the host liquid crystal (5) was 2.24, and YI/Δn was 11.5. Further, the yellowness index of the host liquid crystal (5) was measured in the same manner as for the above host liquid crystal (1).

TABLE 12

host liquid crystal (5)

| Compound | Composition | YI | Δn | YI/Δn |
|---|---|---|---|---|
| A8 | 30.0% | 5.60 | 0.140 | 40.0 |
| B9 | 35.0% | 1.10 | 0.225 | 4.9 |
| B10 | 35.0% | 0.50 | 0.210 | 2.4 |
| Host liquid | 100.0% | 2.24 | 0.194 | 11.5 |
| crystal | | | | |
| composition | | | | |

Each of 50.0% of a mixture containing a compound represented by Formula (A9), 40.0% of a mixture containing a compound represented by Formula (B2), 60.0% of a mixture containing a compound represented by Formula (B3), 15.0% of a mixture containing a compound represented by Formula (B8), and 5.0% of a mixture containing a compound represented by Formula (B11) was added to the host liquid crystal (5) to obtain liquid crystal compositions of Examples 34-1 to 38-3 and Comparative Examples 34-1 to 38-2. Each of the yellowness index (YI), refractive index anisotropy (Δn), and YI/Δn of the liquid crystal compositions of Examples 34-1 to 38-3 and Comparative Examples 34-1 to 38-2 was obtained. Further, the yellowness index of these liquid crystal compositions was obtained in the same manner as for the above host liquid crystal (1).

The evaluation of repellence degree at the time of film production and evaluation of alignment properties of the film were carried out on the liquid crystal compositions of Examples 34-1 to 38-3 and Comparative Examples 34-1 to 38-2 in the same manner as for the liquid crystal composition of the above Examples 14-1 to 18-3 and Comparative Examples 14-1 to 18-2. The results are shown in Table 13.

TABLE 13

| | | | | Amount | | Alignment |
|---|---|---|---|---|---|---|
| | Compound | | YI/Δn | added | repellence | properties |
| Host liquid | Blank | | 11.5 | — | A | A |
| crystal (5) | | | | | | |
| Comparative | A9 | Comparative | 0.8 | 50.0% | C | D |
| Example 34-1 | | Example 2-1 | | | | |
| Example 34-1 | | Example 2-1 | 1.0 | 50.0% | B | B |
| Example 34-2 | | Example 2-2 | 3.3 | 50.0% | A | A |
| Example 34-3 | | Example 2-3 | 50.0 | 50.0% | B | B |
| Comparative | | Comparative | 54.2 | 50.0% | C | D |
| Example 34-2 | | Example 2-2 | | | | |
| Comparative | B2 | Comparative | 0.9 | 40.0% | C | D |
| Example 35-1 | | Example 7-1 | | | | |
| Example 35-1 | | Example 7-1 | 1.1 | 40.0% | B | B |
| Example 35-2 | | Example 7-2 | 40.0 | 40.0% | A | A |
| Example 35-3 | | Example 7-3 | 49.1 | 40.0% | B | C |
| Comparative | | Comparative | 60.0 | 40.0% | D | D |
| Example 35-2 | | Example 7-2 | | | | |
| Comparative | B3 | Comparative | 0.8 | 60.0% | C | C |
| Example 36-1 | | Example 8-1 | | | | |
| Example 36-1 | | Example 8-1 | 1.4 | 60.0% | B | B |
| Example 36-2 | | Example 8-2 | 39.3 | 60.0% | A | A |
| Example 36-3 | | Example 8-3 | 4836.0 | 60.0% | B | C |
| Comparative | | Comparative | 60.7 | 60.0% | D | D |
| Example 36-2 | | Example 8-2 | | | | |
| Comparative | B8 | Comparative | 0.7 | 15.0% | D | D |
| Example 37-1 | | Example 11-1 | | | | |
| Example 37-1 | | Example 11-1 | 1.0 | 15.0% | B | B |
| Example 37-2 | | Example 11-2 | 22.6 | 15.0% | A | A |
| Example 37-3 | | Example 11-3 | 49.7 | 15.0% | C | B |
| Comparative | | Comparative | 56.3 | 15.0% | D | D |
| Example 37-2 | | Example 11-2 | | | | |
| Comparative | B11 | Comparative | 0.4 | 5.0% | C | C |
| Example 38-1 | | Example 12-1 | | | | |
| Example 38-1 | | Example 12-1 | 1.1 | 5.0% | B | B |
| Example 38-2 | | Example 12-2 | 24.6 | 5.0% | A | A |
| Example 38-3 | | Example 12-3 | 49.2 | 5.0% | B | B |
| Comparative | | Comparative | 57.2 | 5.0% | D | D |
| Example 38-2 | | Example 12-2 | | | | |

As seen from Table 5, Table 7, Table 9, Table 11, and Table 13, it was found that in a mixture having a value of YI/Δn falling within a range of 1.0 to 50, occurrence of repellence was prevented and the alignment properties were good.

1. A mixture comprising a compound which has a mesogenic group and satisfying an expression represented by Expression (1):
1.0≦YI/Δn≦50.0 Expression (1)
wherein YI represents a yellowness index of the mixture and Δn represents a refractive index anisotropy of the compound having a mesogenic group.

2. The mixture according to claim 1,
wherein the compound having a mesogenic group has a polymerizable group.

3. A composition comprising:
the mixture according to claim 1.

4. A composition comprising:
the mixture according to claim 1 in a total amount of 5.0% by mass to 90.0% by mass.

5. A liquid crystal composition comprising:
the mixture according to claim 1.

6. A polymer obtained by polymerizing a polymerizable composition containing the mixture according to claim 1.

7. An optical anisotropic body obtained by polymerizing a polymerizable composition containing the mixture according to claim 1.

8. A retardation film obtained by polymerizing a polymerizable composition containing the mixture according to claim 1.

9. A display device comprising:
the optical anisotropic body according to claim 7.

10. An optical element comprising:
the optical anisotropic body according to claim 7.

11. A light-emitting device comprising:
the optical anisotropic body according to claim 7.

12. A printed matter comprising:
the optical anisotropic body according to claim 7.

13. An optical information recording apparatus comprising:
the optical anisotropic body according to claim 7.

14. A composition comprising:
the mixture according to claim 2.

15. A composition comprising:
the mixture according to claim 2 in a total amount of 5.0% by mass to 90.0% by mass.

16. A liquid crystal composition comprising:
the mixture according to claim 2.

17. A polymer obtained by polymerizing a polymerizable composition containing the mixture according to claim 2.

18. An optical anisotropic body obtained by polymerizing a polymerizable composition containing the mixture according to claim 2.

19. A retardation film obtained by polymerizing a polymerizable composition containing the mixture according to claim 2.

20. A display device comprising:
the optical anisotropic body according to claim 18.
